(19) United States
(12) Patent Application Publication
(10) Pub. No.: US 2025/0177872 A1
(43) Pub. Date: Jun. 5, 2025

(54) MULTI-PART CONTROL ADAPTER FOR AN INPUT APPARATUS

(71) Applicant: Ironburg Inventions Limited, Wincanton, Somerset (GB)

(72) Inventors: Jonas Ferry, Dripping Springs, TX (US); Sunil Daddar, Santa Clara, CA (US); W.T. Warmoth, Atlanta, GA (US); Michael Avenancio, Lawrenceville, GA (US); Nick Tanner, Bristol (GB)

(21) Appl. No.: 18/845,960

(22) PCT Filed: Mar. 28, 2022
(86) PCT No.: PCT/IB2022/000163

§ 371 Date: Sep. 11, 2024

(51) Int. Cl. A63F 13/98; A63F 13/24

(52) U.S. Cl. CPC A63F 13/98; A63F 13/24

(57) ABSTRACT

The invention provides an improved multi-part adapter for use with an input apparatus such as a game controller. The input apparatus is shaped to be held in both hands of a user and comprises an outer case having a front face, a top face and a rear face opposing the front face. A control is located on the top face in a position to be operated by a user's index finger. A thumb stick is located on the front face and positioned to be operated by a thumb of the use. The adapter comprises a first part configured to removably couple to a top of the thumb stick, and a second part configured to removably attach to the first part in a manner that applies force to the first part and secures the first part to the thumb stick.

### TECHNICAL FIELD

The present invention relates to an input apparatus for a computer, such as, but not limited to, a games console, and more particularly, but not exclusively the invention relates to, a multi-part adapter for a control of an input apparatus.

### BACKGROUND

Controllers for most current game consoles are generally intended to be held and operated by the user holding the controller in both hands, or as separate controllers with one held in each hand. Such controllers may be referred to as “gamepads”, “joypads” or “Joy-Cons®” or by other names. A conventional controller will generally comprise an outer case with a plurality of controls mounted about the controller. Typically, the controls include buttons, one or more analogue control sticks, bumpers and triggers and are provided upon the front or the top of the controller.

An object of the present invention is to provide a removable adapter for one or more of the controls of an input apparatus for a computer, and in particular for analogue control sticks or thumb sticks of the input apparatus. It is desirable that the removable adapter is both ergonomic/comfortable to use and securely affixed to the control so that a user can manipulate the control without the adapter interfering with the operation of the control, such as by the user's thumb slipping off the adapter or the adapter moving or twisting with respect to the control.

The present invention seeks to overcome or at least mitigate the problems of the prior art.

### SUMMARY

A first aspect of the present disclosure provides an input apparatus with an outer case. The outer case has a front face, a top face, and a rear face opposing the front face. The input apparatus has a control located on the top face and the apparatus is shaped to be held in both hands of a user such that the user's index fingers are positioned to operate the control located on the top of the apparatus. The input apparatus has a second control located on the front face in a position to be operated by a thumb of the user. An adapter is provided, with the adapter configured to be removably attached to the second control. The adapter comprises a collet configured to couple to a top or head of the second control, and a cover configured to removably attach to the collet in a manner that secures the collet to the second control, wherein the cover provides an engagement surface for the user's thumb.

Advantageously, the cover increases the security or grip of the collet to the second control. The collet comprises a grip device and the cover interacts with the grip device to inhibiting opening of the grip device and may act to close the grip device about the second control.

Optionally, the cover is configured to be press fit to the collet, while in other aspects other means of securing may be used, such as screwing the cover onto the collet to secure the collet to the second control.

Optionally, the collet may comprise a central portion from which a plurality of extensions extend to wrap around or engage the sides of a top of a thumb stick. The extensions may be made of a semi-flexible material with one end of the extensions rigidly attached to the central portion such that the extensions can bend or flex downwards and inwards towards the upper surface and/or sides of the top of the thumb stick. The cover may be configured to removably attach to the collet to tighten the collet around the top of the thumb stick and securely attach the adapter to the thumb stick. The cover may comprise an outer side/engagement surface providing a surface for a user's thumb to engage when the adapter is attached to the thumb stick and an inner side providing the mechanism for cover to removably attach to the collet and secure the collet to the thumb stick.

Optionally, the collet may instead comprise a ring with a central opening, where the ring includes a series of compression or expansion gaps configured to deform to secure the ring to the top of the thumb stick. The ring may also include a plurality of projections extending downwardly from a bottom edge of the ring to allow the projections to grip or attach to a bottom surface of the top of thumb stick. The cover may comprise an outer side/engagement surface providing a surface for a user's thumb to engage when the adapter attached to the thumb stick and an inner side providing the mechanism for the cover to removably attach to the collet.

Optionally, the collet comprises a ring with a centre opening configured to engage a side of the top of the thumb stick, the ring is configured with a compression gap interrupting the ring, and a plurality of projections extending from the bottom edge of the ring.

Optionally, the cover comprises a plurality of protrusions configured to engage the side of the top of the thumb stick when the cover is attached to the collet, and portions of the side wall of the cover, located between the protrusions, are configured to engage and apply pressure to the plurality of extensions to secure the collet to the thumb stick.

Optionally, the cover is configured to apply force to the extensions in two directions.

Optionally, the cover comprises a central protrusion configured to apply pressure to the ring when the cover is attached to the collet such that the collet is secured to the thumb stick.

Optionally, the cover is formed from a first material and the collet is formed from a second material different from the first material.

Optionally, the collet comprises a central portion configured to engage an upper surface of the top of the thumb stick, an inner annular wall depends from the central portion and is configured to engage a side of the top of the thumb stick, and an outer annular wall extends from the inner wall to define a channel therebetween.

Optionally, the collet comprises a skirt extending inwardly from the inner wall and defining a shelf for engaging a bottom of the top of the thumb stick.

Optionally, the cover comprises a collar configured to be received in the channel.

Optionally, the cover is configured to snap-fit to the collet.

Optionally, the collet comprises a central portion having an opening defined in part by an aperture and in part by an annular series of displaceable tabs disposed about the aperture and the cover comprises a retainer pin configured to push-fit into the opening in the collet, wherein said tabs engage the retainer pin.

The retainer pin comprises a head portion having a dimension greater than the aperture, the tabs being displaceable to create an opening sufficiently large to allow the head portion to pass through, such that a shaft connecting the head portion to the cover extends through the aperture. The aperture may be sufficiently large in dimension to accommodate the shaft when the tabs are in a rest position, an undeformed or undisplaced condition.

A second aspect of the present disclosure provides an input apparatus with a removable cover secured to the top of a thumb stick via securing mechanism attached to an outer surface of the removable cover. The inner surface of the removable cover may be configured to attach to and grip the top of the thumb stick, while the outer surface of the cover is configured to provide an engagement surface for a user. The cover may include a side wall configured to extend over and secure to the side of the top of the thumb stick. The outer surface of cover may provide a way for securing mechanism to attach to the cover, which may be an indention configured to accept a securing mechanism comprising a semi-rigid ring.

A third aspect of the present disclosure provides an adapter for use with a game controller. The game controller is shaped to be held in both hands of a user and comprises an outer case with a front face, a top face and a rear face opposing the front face. The game controller also comprises a control located on the top face in a position to be operated by a user's index finger and a thumb stick located on the front face and positioned to be operated by a thumb of the user. The adapter comprises a first part configured to removably couple to a top of the thumb stick and a second part configured to removably attach to the first part in a manner that applies force to the first part and secure the first part to the thumb stick.

A fourth aspect of the present disclosure provides an input apparatus for a computer. The input apparatus comprises an outer case having a front face, a top face and a rear face opposing the front face. The input apparatus comprises a control located on the top face, the apparatus is shaped to be held in both hands of a user such and the user's index fingers are positioned to operate the control located on the top of the apparatus. The input apparatus comprises a second control located on the front face and positioned to be operated by a thumb of the user. An adapter is provided, with the adapter configured to be removably attached to the second control and provide an engagement surface for the user's thumb. The adapter comprises a first part configured to couple to a top of the second control, and a second part configured to removably attach to the first part in a manner that secures the first part to the second control.

Optionally, the first part comprises a grip device and at least one fitment gap for allowing compression of the grip device.

Optionally, the first part comprises a removable cover and the second part comprises a securing mechanism configured to engage an outer surface of the cover to secure the cover to the thumb stick.

Optionally, the removable cover comprises a central portion and a plurality of fingers extending from the central portion, the plurality of fingers forming a sidewall of the removable cover, and the securing mechanism comprises a deformable ring configured to engage an indention formed in an outer surface of each of the plurality of fingers.

Optionally, the engagement surface comprises a shapeable material configured to be customised to the thumb of the user.

Within the scope of this application, it is envisaged or intended that the various aspects, embodiments, examples, features and alternatives set out in the preceding paragraphs, in the claims and/or in the following description and drawings may be considered or taken independently or in any combination thereof.

Features or elements described in connection with, or relation to, one embodiment are applicable to all embodiments unless there is an incompatibility of features. One or more features or elements from one embodiment may be incorporated into, or combined with, any of the other embodiments disclosed herein, said features or elements extracted from said one embodiment may be included in addition to, or in replacement of one or more features or elements of said other embodiment.

A feature, or combination of features, of an embodiment disclosed herein may be extracted in isolation from other features of that embodiment. Alternatively, a feature, or combination of features, of an embodiment may be omitted from that embodiment.

Further features and advantages of the present invention will be apparent from the specific embodiments illustrated in the drawings and discussed below.

### BRIEF DESCRIPTION OF THE DRAWINGS

Exemplary embodiments of the invention will now be described with reference to the accompanying drawings, in which:

FIG. 1A is a schematic illustration of the front of an input apparatus for a games console controller according to an embodiment of the present disclosure;

FIG. 1B is a perspective view from above of the input apparatus of FIG. 1A;

FIG. 1C is an illustration of the front of the input apparatus of FIG. 1A when held by a user;

FIG. 2 is an exploded perspective view from above of an embodiment of a multi-part removable control adapter for use with an input apparatus and a control of an input apparatus, such as the input apparatus of FIG. 1A or 1B;

FIG. 3 is a perspective view from below of a first part of the embodiment of the multi-part removable control adapter illustrated in FIG. 2A;

FIG. 4A is a perspective view from below of a second part of the embodiment of the multi-part removable control adapter illustrated in FIG. 2A;

FIG. 4B is a plan view of the second part of the embodiment of the multi-part removable control adapter illustrated in FIG. 4A;

FIG. 5 is a side view of the second part of the embodiment of the multi-part removable control adapter illustrated in FIG. 4A;

FIG. 6 is a perspective view from below of the embodiment of the multi-part removable control adapter illustrated in FIG. 2A with the control adapter assembled;

FIG. 7 is a side view of the embodiment of the multi-part removable control adapter illustrated in FIG. 2A with the control adapter assembled, a control of the input apparatus of FIG. 1A is shown in phantom lines;

FIG. 8A is a perspective view from below of a first part of an embodiment of a multi-part removable control adapter for use with an input apparatus, such as the input apparatus of FIG. 1A or 1B;

FIG. 8B is a perspective view from above of the first part of the multi-part removable control adapter illustrated in FIG. 8A;

FIG. 9A is a perspective view from below of a second part of an embodiment of a multi-part removable control adapter for use with an input apparatus, such as the input apparatus of FIG. 1A or 1B;

FIG. 9B is a side view from above of the second part of the multi-part removable control adapter illustrated in FIG. 8A;

FIG. 10A is a perspective view from above of a multi-part removable control adapter formed from the first part of FIG. 8A and the second part of FIG. 9A in an assembled condition;

FIG. 10B is a side view of the multi-part removable control adapter illustrated in FIG. 10A;

FIG. 11 is a perspective view from below of a multi-part removable control adapter formed from the first part of FIG. 8A and the second part of FIG. 9A in an assembled condition;

FIG. 12 is an exploded perspective view from above of an embodiment of a multi-part removable control adapter for use with an input apparatus such as the input apparatus of FIG. 1A or 1B;

FIG. 13A is a side view of the multi-part removable control adapter illustrated in FIG. 12;

FIG. 13B is a side view of the multi-part removable control adapter illustrated in FIG. 12 in an assembled condition;

FIG. 14A is a perspective view from above of the multi-part removable control adapter illustrated in FIG. 12 in an assembled condition;

FIG. 14B is a perspective view from below of the multi-part removable control adapter illustrated in FIG. 12 in an assembled condition;

FIG. 15A is a perspective view from above of an embodiment of a multi-part removable control adapter for use with an input apparatus such as the input apparatus of FIG. 1A or 1B;

FIG. 15B is a side view of the multi-part removable control adapter illustrated in FIG. 15A;

FIG. 16 is a perspective view from below of a first part of the multi-part removable control adapter illustrated in FIG. 15A;

FIG. 17 is a perspective view from below of a second part of the multi-part removable control adapter illustrated in FIG. 15A;

FIG. 18A is a perspective view from above of the second part of the multi-part removable control adapter illustrated in FIG. 15A;

FIG. 18B is an exploded side view the multi-part removable control adapter illustrated in FIG. 15A;

FIG. 19 is a perspective view from below of the multi-part removable control adapter illustrated in FIG. 12 in an assembled condition;

FIGS. 20A and 20B are sectional views of portions of the multi-part removable control adapter illustrated in FIG. 12 showing a first, engaged, condition alongside a second, disengaged condition;

FIG. 21A is a perspective view from above of an embodiment of a multi-part removable control adapter for use with an input apparatus such as the input apparatus of FIG. 1A or 1B;

FIG. 21B is a perspective view from below of a first part of the multi-part removable control adapter illustrated in FIG. 21A;

FIG. 22A is a perspective view from above of a second part of the multi-part removable control adapter illustrated in FIG. 21A;

FIG. 22B is a perspective view from below of the second part of the multi-part removable control adapter illustrated in FIG. 21A;

FIGS. 23A and 23B are perspective views from below of the multi-part removable control adapter illustrated in FIG. 21A.

FIG. 24 is a perspective view from above of an embodiment of a multi-part removable control adapter control adapter for use with an input apparatus such as the input apparatus of FIG. 1A or 1B;

FIG. 25A is a side view of a first part of the multi-part removable control adapter illustrated in FIG. 24;

FIG. 25B is a side view of a second part of the multi-part removable control adapter illustrated in FIG. 24;

FIG. 26A is a plan view from below of a first part of the multi-part removable control adapter illustrated in FIG. 24;

FIG. 26B is a plan view from above of a second part of the multi-part removable control adapter illustrated in FIG. 24;

FIG. 27A is a perspective view from below of a first part of the multi-part removable control adapter illustrated in FIG. 24;

FIG. 27B is a perspective view from above of a second part of the multi-part removable control adapter illustrated in FIG. 24; and

FIG. 28 is a perspective view from below of the multi-part removable control adapter control adapter of FIG. 24 in an assembled condition.

### DETAILED DESCRIPTION

Detailed descriptions of specific embodiments of an adapter for use on a control of an input apparatus and an input apparatus implementing the adapter are disclosed herein. It will be understood that the disclosed embodiments are merely examples of the way in which certain aspects of the disclosed adapter can be implemented and do not represent an exhaustive list of all of the ways the adapter may be embodied. As used herein, the word “exemplary” is used expansively to refer to embodiments that serve as illustrations, specimens, models, or patterns. Indeed, it will be understood that the adapter, control, and/or input apparatus described herein may be embodied in various and alternative forms. The Figures are not necessarily to scale and some features may be exaggerated or minimised to show details of particular components. Well-known components, materials or methods are not necessarily described in great detail in order to avoid obscuring the present disclosure. Any specific structural and functional details disclosed herein are not to be interpreted as limiting, but merely as a basis for the claims and as a representative basis for teaching one skilled in the art to variously employ the invention.

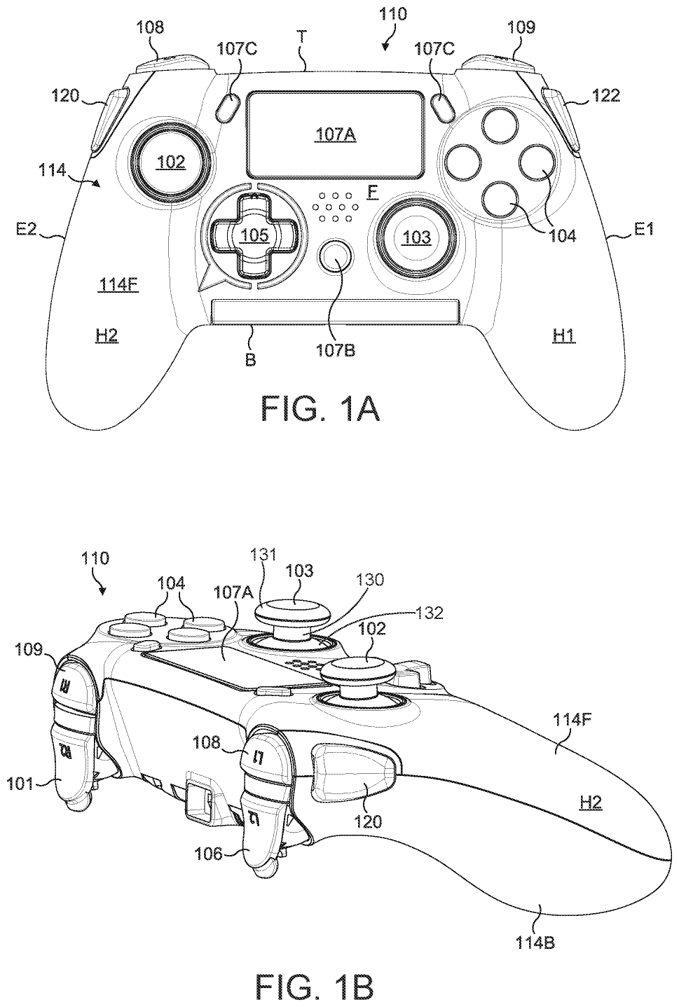

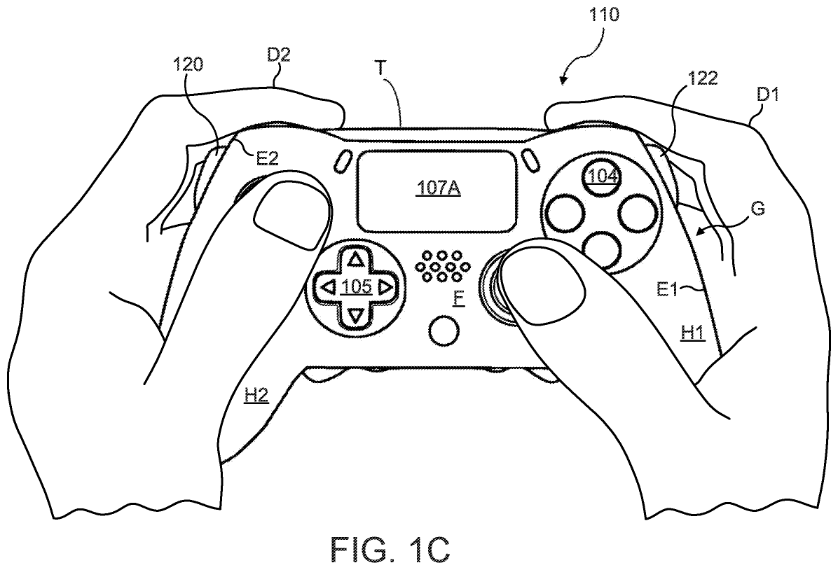

Referring to FIG. 1A there is shown a plan view from above of the front of an input apparatus 110 for a use with a computer. The input apparatus 110 illustrated takes the form of a controller 110 or game pad 110 for use with a video games console, personal computer, laptop computer, mobile device, cloud gaming system, or similar. In other embodiments, the input apparatus 110 may take the form of a handheld games console or other mobile device such as but not limited to a smartphone, tablet computer, phablet or the input apparatus 110 may be, or may be incorporated into, an accessory device (such as, but not limited to, a sleeve or case) for use with such a mobile device.

In an embodiment, the apparatus or controller 110 comprises an outer case or shell 114. The case 114 may comprise one or more panels fitted together and or mounted to a chassis member. The case 114 may comprise a front body panel 114F and a rear body panel 114B (see FIG. 1B). The outer case 114 comprises a void in which electronic components (such as, but not limited to, switches 138 and/or sensors) are located. In other embodiments, the input apparatus 110 may not comprise a single case 114 held in both hands of a user, but may instead comprise two separate or separable portions, with one portion held in each of a user's hands. In such embodiments, each separate portion may have its own case (not illustrated) and each portion may individually or separately provide inputs to the computer.

The apparatus or controller 110 comprises a plurality of controls which are mounted to the front F and to the top T of the controller 110. As used herein the term “front” refers to an upper surface of the controller 110 when in normal use held in both hands, whilst the term “top” refers to a leading edge of the controller 110 which typically faces away from a user when held in both hands. A rear or back of the controller opposes the “front” and typically will form a lower surface, whilst the term “bottom” B refers to a trailing edge of the controller 110 which typically faces towards the user when held in both hands. The controller 110 comprises a plurality of buttons which when activated initiate a specific action or control function. The controller 110 comprises at least one omnidirectional control stick or button which is operable to provide directional input.

Specifically, in the illustrated example shown, the controller 110 comprises first, left, and second, right, analogue control sticks, also known as thumb sticks 102, 103. The first left 102 and second right 103 thumb sticks normally control movement and are intended to be operated by the user's left and right thumbs respectively. Left and right thumb sticks 102, 103 are mounted to the front face F of the controller 110. The left thumb stick 102 is located in a forward (or upper i.e. nearer the top T of the controller 110) left region of the front face F; and right thumb stick 103 is located in a rearward (or lower i.e. nearer the bottom B of the controller 110) right region of the front face F. Note than in the event that the controller 110 comprises separate portions rather than a single case 114 as illustrated in FIGS. 1A and 1B, each of the separate portions may have a thumb stick 102/103, or only one portion may have a thumb stick 102/103. The adapter disclosed herein is equally applicable to any such input device, such as controller 110 which implements a thumb stick 102/103 or thumb-based control, regardless of the number of thumb sticks, configuration of the thumb sticks, and/or the configuration of the input device.

In the illustrated embodiment, there are four buttons 104, located on a forward (or upper i.e., nearer the top T of the controller 110) right portion of the front face F of the controller 110. The four buttons 104 normally control additional actions and are intended to be operated by the user's right thumb. There is a direction pad 105 located on the rearward (or lower) left portion of the front face F of the controller 110. The direction pad 105 is intended to be operated by the user's left thumb, typically either as an alternative to the left thumb stick 102 or to provide additional action controls. A left shoulder button or bumper 108 and a right shoulder button or bumper 109 are located on the top face T of the controller 110. A left trigger 106 and a right trigger 101 are also located on the top face T of the controller 10 (see FIG. 1B). The left and right triggers 106, 101 are typically operated by a user's index fingers. The left and right bumpers 8, 9 may also be operated by a user's index fingers. The left and right triggers 106, 101 may be analogue in nature, or may comprise a plurality of discrete digital states, that is to say the input control may be dependent upon the degree of depression or displacement of the trigger body.

The controller 110 may comprise one or more additional input buttons 107A, 107B, 107C, the buttons 107A, 107B, 107C may take the form of one or more digital or analogue buttons, or may be in the form of a touch pad or touch screen.

In order to operate any of the buttons 104 a user will normally remove their right thumb from the right thumb stick 103 so as to depress one or more of the buttons 104. Switching between the right thumb stick 103 and the buttons 104 takes time since the user's thumb must traverse the distance therebetween. This may also cause a loss of, or reduction in, control in some games because the user has to relinquish control over the right thumb stick 103 in order to control the buttons 104. This may be a particular problem in games where the right thumb stick 103 is used for aiming. A similar problem may arise in games where the direction pad 105 provides additional actions and the user has to remove their left thumb from the left thumb stick 102 in order to operate the direction pad 105.

The controller 110 may comprise one or more additional controls (not shown) mounted to the rear or back of the apparatus 110, where the rear or back face is opposite the top face F (the face F to which the buttons 104, left and right thumb sticks 102, 103 and direction pad 105 are mounted).

For the illustrated embodiment, in order to operate the controls mounted upon the top T of the controller 110 a user will normally wrap their index fingers about the side edges or walls E1, E2 of the controller case 114, as shown in FIG. 1C. In FIG. 1C the index fingers D1, D2 are bent or crooked about forward or leading corners of the controller 110.

The user can operate either the left shoulder button 108 or left trigger 106 with the index finger D2 of their left hand and can operate either the right shoulder button 109 or right trigger 101 with the index finger D2 of their right hand (see FIG. 1C).

The user may also wrap their middle fingers about the side edges or walls E1, E2 of the controller case 114. The middle fingers may be bent or crooked about forward or leading corners of the controller 110. The user can operate the left shoulder button 108 with the index finger D2 of their left hand and can operate the right shoulder button 109 with the index finger D2 of their right hand and may operate the left trigger 106 with the middle finger of their left hand and may operate the right trigger 101 with the middle finger of their right hand.

The user may place the pad of the end of their index fingers D1, D2 and/or middle fingers on the controls on the top of the controller 110. When doing so the user fingers may leave a gap G between side walls E1, E2 of the controller case 114 and the adjacent finger.

Optionally, controller 110 may provide one or more additional controls 120, 122 upon at least one of the side walls E1, E2 of the controller case 114 proximate the top or leading edge T of the controller 110. The additional controls 120, 122 may be disposed in an upper region of the side walls E1, E2 of the controller case 114 that is to say proximate the front F of the controller 110. The additional controls 120, 122 are disposed in the crook of a respective one of the index fingers D1, D2, the additional controls 120, 122 may at least partially fill the gaps G.

The additional control 120, 122 are arranged to be operated by a user engaging or pressing the control 120, 122 with one of the phalanges of the index finger D1, D2 or middle finger, preferably the user's proximal phalanx or rather the fleshy part thereabout. In this way the additional controls 120, 122 are operable by an intermediate portion of the user's index or middle finger, wherein the intermediate portion is disposed between the finger pad or end of the finger and the metacarpophalangeal joint.

The present disclosure provides for at least one adapter configured to removably attach to a control of an input apparatus, such as illustrated controller 110. In an embodiment, the adapter is configured to removably attach to a thumb stick such as thumb stick 102/103. As illustrated in FIG. 1B, a typical thumb stick 103/102 may include a base 132 configured to attach (either removably or permanently) to the controller 110, such as to a motion or position sensor (not illustrated) which can include a potentiometer, hall effect sensor, capacitive sensor, optical sensor, etc. Base 132 of thumb stick 103 may be partially or wholly contained within the outer case of controller 110. Thumb stick 103 also includes a top or head 130 located partially or wholly outside of the outer case of controller 110, with the top 130 being engaged by the user's thumb as illustrated in FIG. 1C. In an embodiment, the top 130 may be generally circular in shape as illustrated in FIG. 1B with an upper surface engaged by the user and a lower surface coupled to a stem or shaft 131, with the stem 131 connecting the top 130 of thumbs stick 103 to the base 132. The upper surface of the top 103 may be convex or concave as desired. In an embodiment the top 130, the stem 131, and the base 132 may be permanently connected to form a unitary thumb stick 103, while in another embodiment, the top 130 may be removable from the base 132, such as by removably attaching the top 130 to the stem 131 or removably attaching the stem 131 to the base 132, or both. Although discussed in terms of the thumb stick 103, the above and below discussion is equally applicable to the thumb stick 102.

The top 130 of the thumb stick 103 is typically formed from a rubber, plastic, or polymer material and/or includes a rubber or plastic upper surface. Tops 130 formed out of a harder rubber/plastic/polymer can be uncomfortable to a user's thumbs, especially when the controller 110 is used for extended periods. Tops 130 formed from a softer rubber/plastic/polymer material are more comfortable to use but can wear out quickly over time. It is desirable to provide an adapter for the thumb stick 103 to allow changing the surface material of the top 130 and/or replacing a worn top 130. However, current unitary or one-piece adapters that clamp onto the top 130, are subject to twisting on the top 130 during use and/or loosening over time.

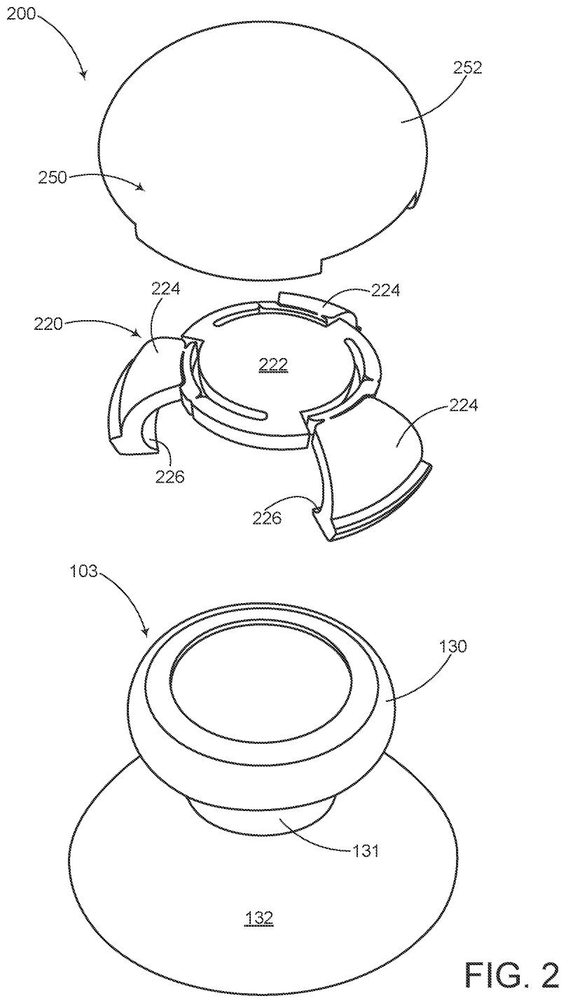

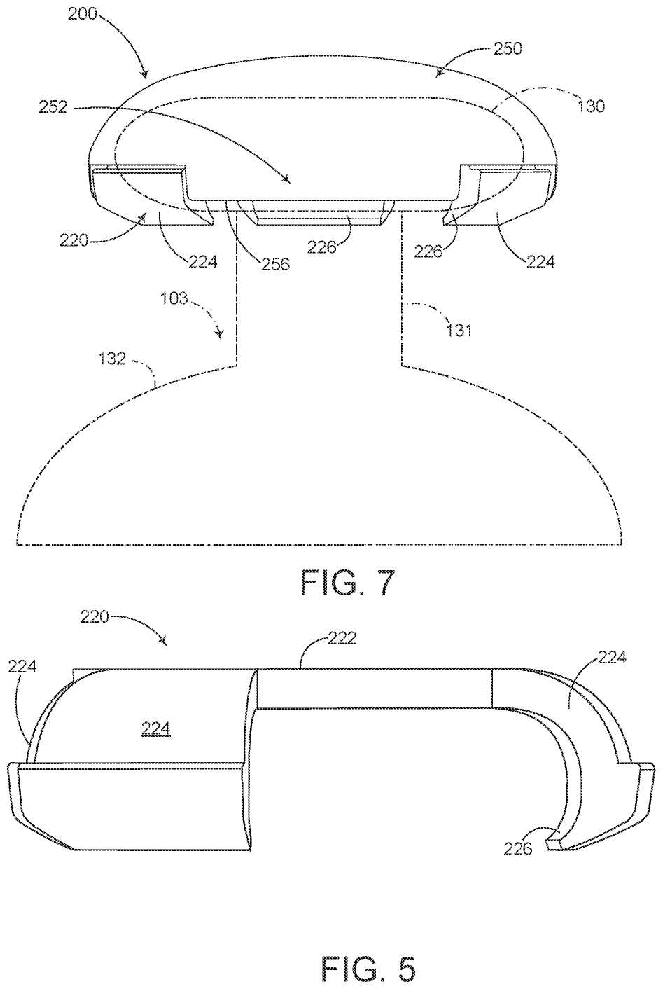

To address these various issues and provide a more secure adapter, FIGS. 2 to 7 illustrate an embodiment of a multi-part removable adapter 200 configured to removably attach to a control of controller 110, such as the thumb stick 103. Adapter 200 comprises a collet 220 configured to grip the top 130 of thumb stick 103 and a cover 250 configured to attach to the collet 220 and provide an engagement surface for a user. In the illustrated embodiment, the collet 220 comprises a central portion 222 from which a plurality of extensions or jaws 224 extend. The extensions 224 may be nonlinear or curved in shape so as to extend generally outward and downward from the central portion 222 best illustrated in FIG. 5.

The collet 220 is configured to removably attach to the thumb stick 103 with central portion 222 resting on an upper surface of the top 130 of the thumb stick 103, and the extensions 224 wrapping around, or engaging, the sides of top 130 of the thumb stick 103. The collet 220 receives the head 130 of the thumb stick 103. One or more of extensions 224 may be configured with a ledge or projection 226 at the end of the extension 224 opposite the end connected to the central portion 222. In an embodiment, the projections 226 may comprise a ledge or shelf extending from an inside face of the extensions 224. The projection 226 may be shaped and sized to allow the extensions 224 to grip or attach to a bottom surface of the top 130 of the thumb stick 103 to help secure the collet 220 to the top 130 while at the same time preventing the collet 220 (and adapter 200) from twisting on the thumb stick 103 in use.

The extensions 224 may be made of a semi-flexible material with one end of the extensions 224 rigidly attached to the central portion 222 such that the extensions 224 can bend or flex downwards and inwards towards the upper surface and/or sides of the top 130 of the thumb stick 103 in response to pressure to provide a secure attachment to top 130. In another embodiment, the extensions 224 may be made of a more rigid material and may be pivotally or rotationally attached to the central portion 222 such that the extensions 224 can pivot or rotate downwards and/or inwards somewhat towards the upper surface and/or sides of the top 130 of the thumb stick 103 in response to pressure to provide a secure attachment to the top 130.

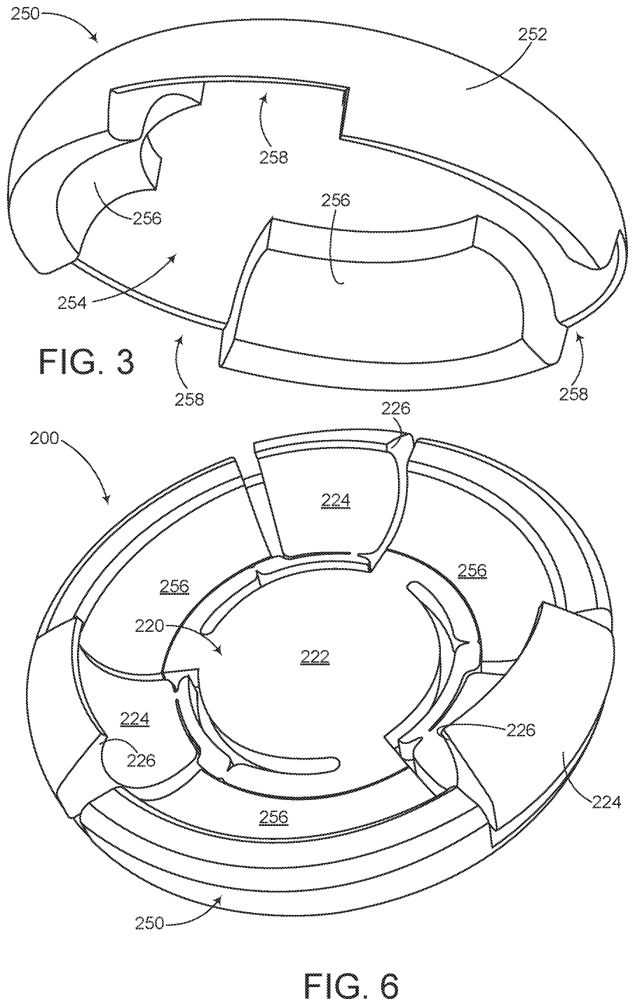

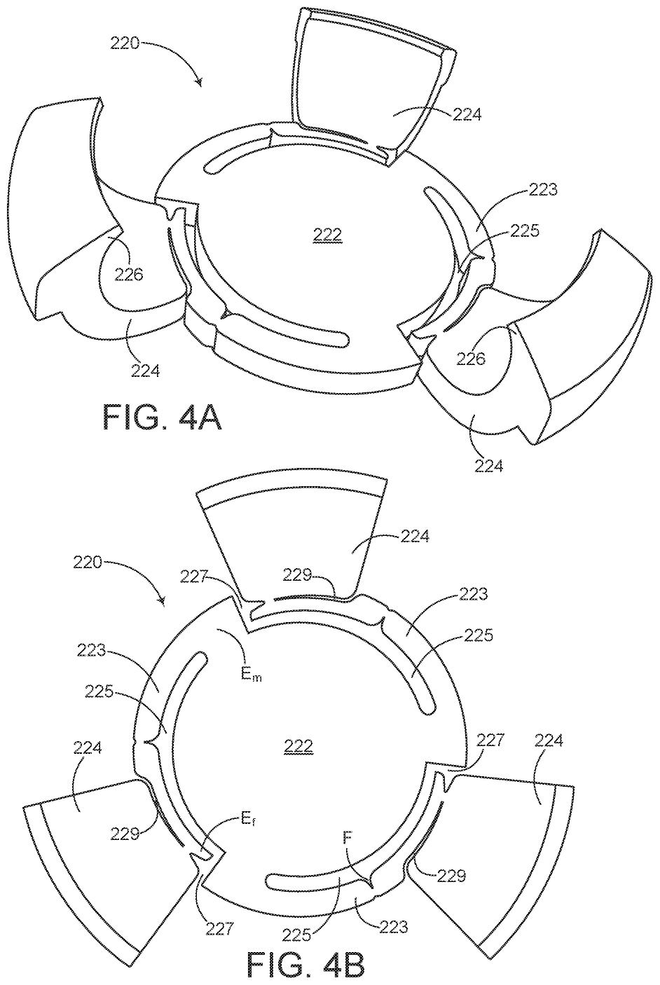

In the illustrated embodiment, each extension 224 is mounted to a first, floating or free, end Eₜ of an arm 223, best shown in FIG. 4B. The arm 223 is mounted at a second, fixed, end Eₘ to the central portion 222. The arm is spaced apart from the central portion 222 by a gap or slot 225. The arm 223 is movable inwardly towards the central portion 222 by bending or deformation of the arm 223, or pivoting of the arm 223 about second, fixed, end Eₘ. The arm 223 may comprise a cut-out or waist F. The waist F may provide a living hinge, increasing the flexibility of the arm 223.

The extension 224 may be moveably mounted to the arm 223. At least one second gap or slot 229 may separate a portion of extension 224 from the arm 223. In this way the extension 224 may pivot or rotate with respect to the arm 223, albeit to a lesser extent than the degree of movement of the arm 223 with respect to the central portion 222.

The extensions or jaws 224 may be opened outwardly to receive the head 130 of the thumb stick 103 therebetween.

Cover 250 is configured to removably attach to the collet 220 to tighten the collet 220 around the top 130 to securely attach the adapter 200 to the thumb stick 103. The cover 250 comprises an outer side/engagement surface 252 and an inner side 254 opposite the outer side 252. The outer side/engagement surface 252 provides a surface for a user's thumb to engage when the adapter 200 is attached to a thumb stick 103 in order to operate the thumb stick 103. The upper portion of the engagement surface 252 may be concave, convex, or any other desired shape. The inner side 254 provides the mechanism for the cover 250 to removably attach to the collet 220.

In the embodiment of FIGS. 2 to 7 the cover 250 may press fit onto the collet 220 such that when the cover 250 is attached to the collet 220, the cover 250 provides force or pressure to the extensions 224 of the collet 220 to secure the adapter 200 to the top 130 of the thumb stick 103. The cover 250 may encourage the arms 223, or at least a portion of the arm 223 proximate the first, floating or free, end Eₜ, to be displaced inwardly towards the central portion 222. The cover 250 may prevent or inhibit outward movement of the arms 223, or at least the portion of the arm 223 proximate the first, floating or free, end Eₜ, so as to inhibit release of the collet 220 from the head 130 of the thumb stick 103. In other embodiments, the cover 250 may attach to the collet 220 by another method to provide force or pressure to the extensions 224 of the collet 220 to secure the adapter 200 to the top 130 of the thumb stick 103. For example, in an alternate embodiment the cover 250 could be configured to screw down on to the collet 220 to provide pressure to the extensions 224, such as by threads formed on the inner side 254 of the cover 250 to engage the outside surface of the collect 220 and/or the extensions 224.

For the press fit cover 250 of FIGS. 2 to 7, the inner side 254 comprises a series of protrusions 256, best shown in FIG. 3. Protrusions 256 are located and dimensioned so as to fit in between the space between the extensions 224 of the collet 220 (as shown in FIG. 6), such that the inner surface of the protrusions 256 may also engage with the side surface of the top 130 of the thumb stick 103. The protrusions 256 are spaced such that the side wall of the cover 250 between the protrusions 256 can engage with the extensions 224 of the collet 220 to provide downward and inward pressure on extensions 225 when the cover 250 is press fit onto the collet 220, securing the collet 220 firmly onto the upper surface and sides of the top 130 of the thumb stick 103, as shown in FIG. 7 in which the position of the thumb stick 103 is illustrated by phantom, dot-dash, lines. The downward and inward pressure prevents the collet 220 (and therefore the adapter 200) from slipping, moving or twisting with respect to the top 103 of the thumb stick 130 when the cover 250 is press fit to the collet 220.

Additionally, the location and dimension of protrusions 256 allow for the cover 250 material to be the primary material exposed to the user when the adapter 200 is attached to the top 130 of thumb stick 103. For instance, FIGS. 2 to 7 illustrate the adapter 200 with the cover 250 press fit onto collet 220. As illustrated in FIG. 7, when the cover 250 is attached to the collet 220 the engaging surface 252 engaged by a user is not only on the top of the adapter 250, but also includes the outer surface of the protrusions 256 which extend down to cover the side of the top 130 of the thumb stick 103. In some embodiments, the cover 250 and the collet 220 may be made or formed from the same material, while in other embodiments the cover 250 may be formed from or made from a different material than the collet 220. Any suitable material for the cover 250 and/or the collet 220 may be used such as a plastic, resin, elastomer, polyvinyl chloride, polystyrene, vinyl, or other deformable material.

In an embodiment, the collet 220 may be made of a first material that is more durable and/or that will better secure the adapter 200 to the top 130 of thumb stick 103, while the cover 250 may be made of a second material that provides a better engagement surface for a user. For example, the collet 220 may be made of a first, firmer, more durable or rigid material, while the cover 250 may be made of a softer material and/or a material that provides more friction with a user's thumb to provide comfort and/or prevent slipping during operation of the thumb stick 103. Additionally, since the cover 250 is removable, covers 250 of different materials, colours, shapes, thicknesses, widths, textures, etc. can be used with the adapter 200 as desired by a user. In this manner covers 250 with different properties may be readily switched or changed on the adapter 200 when desired by a user such as, but not limited to; to replace a worn cover 250, to provide a different feel to the user, to allow for different performance characteristics when playing different types of games, or to switch between users with different sized/shaped hands or thumbs, etc.

Additionally, in an embodiment, the cover 250 may be customizable for a particular use or user, such as by using a thermo or thermoset plastic or polymer, or other customizable material, for part or all of the cover 250. In an embodiment using a thermoplastic for example, the thermoplastic portion of the cover 250 may be heated and formed to a desired shape by the user (for example to conform to the shape or contours of the user's thumb), and then cooled to fix the desired shape of the cover 250 which may then be used with the adapter 200. It is envisioned for such embodiments that a user may customizable a first cover 250 for the user's left thumb and a second cover 250 for the user's right thumb and/or that a first user may create a first cover 250 (or a first set of covers 250) while a second user may create a second cover 250 (or second set of covers 250) for use with the adapter 200.

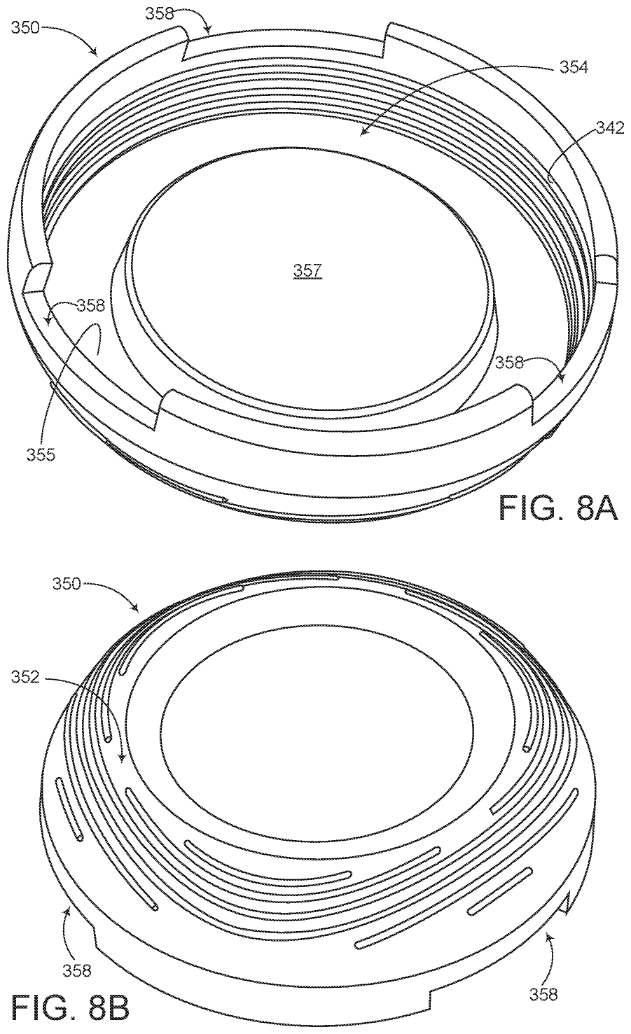

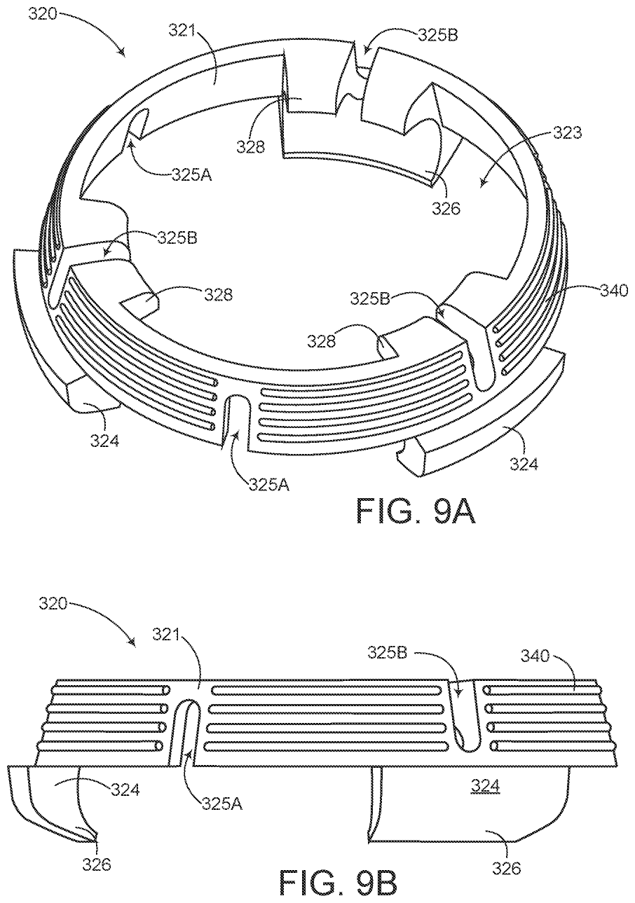

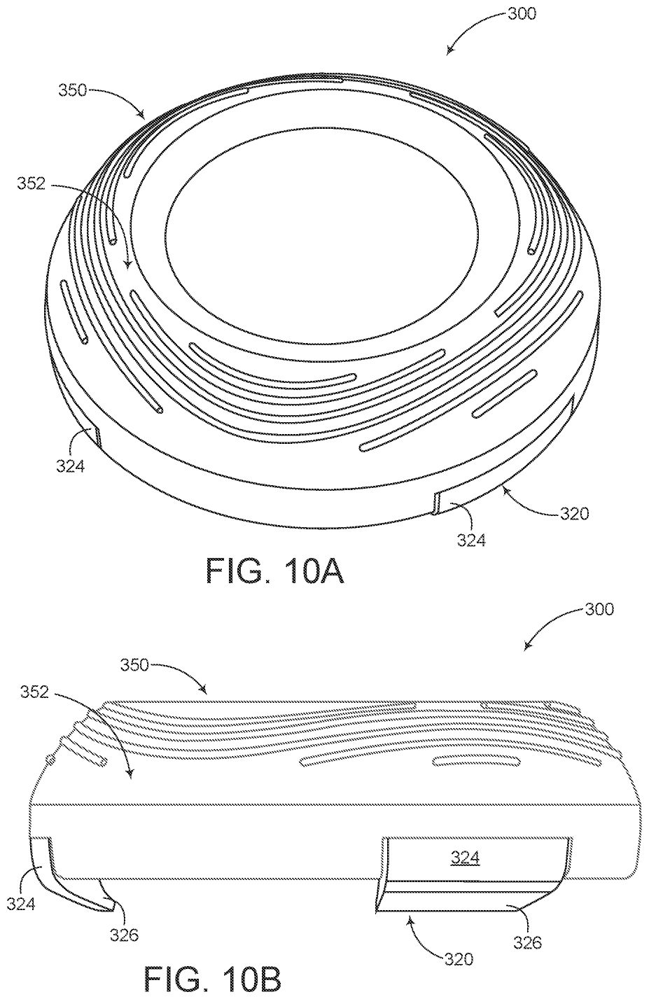

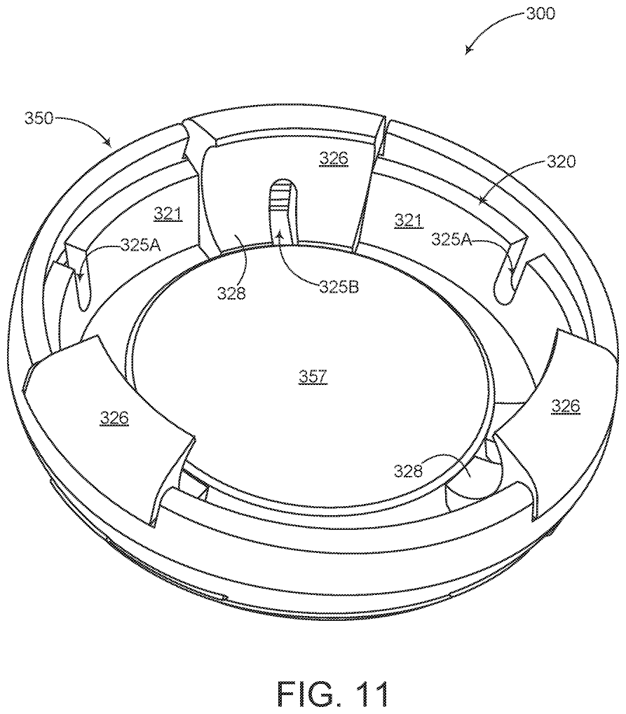

FIGS. 8A to 11 illustrate a second embodiment of a multi-part removable adapter 300 (see FIG. 10A) configured to removably attach to a control of controller 110, such as thumb stick 103. Adapter 300 comprises a collet 320, as shown in FIGS. 8A and 8B, configured to grip the top 130 of the thumb stick 103 and a cover 350, as shown in FIGS. 9A and 9B, configured to attach to the collet 320 and provide an engagement surface for a user. In the illustrated embodiment, the collet 320 comprises a ring 321 with a central opening 323. The ring 321 includes a series of compression gaps 325A, 325B (also referred to herein as fitment or configuration gaps) configured to deform to secure the ring 321 to the top 130 of the thumb stick 103. The fitment or configuration gaps 325A, 325B allow the ring to adjust its geometry, its size and/or shape, to fit the head 103 of the thumb stick 103, in doing so some fitment or configuration gaps 325A, 325B may contract while others may expand. The ring 321 also includes a plurality of projections or jaws 324 extending downwardly from a bottom edge of the ring 321. The projections 324 may comprise a ledge or shelf 326 and may be shaped and sized to allow the jaws 324 to grip or attach to a bottom surface of the top 130 of the thumb stick 103 to help secure the collet 320 to the top 130 while at the same time preventing the collet 320 (and adapter 300) from twisting on the thumb stick 103 in use.

The collet 320 comprises at least one compression gaps 325A, 325B. The collet 320 may comprises at least one first or lower compression gaps 325A. The collet 320 may comprises at least one second or upper compression gaps 325B. In the illustrated embodiment, the collet 320 comprises a plurality of first or lower compression gaps 325A, specifically, but not limited to, three lower compression gaps 325A. The collet 320 may comprises at least one second or upper compression gaps 325B. In the illustrated embodiment, the collet 320 comprises a plurality of second or upper compression gaps 325B, specifically, but not limited to, three lower compression gaps 325B.

The collet 320 may comprise a second or upper compression gaps 325B struck from, or defined in, an upper portion of the ring 321 substantially above, or aligned with, each projection or jaw 324.

The collet 320 may comprise a first or lower compression gaps 325A struck from, or defined in, a lower portion of the ring 321, each first or lower compression gaps 325A may be located on the ring 321 substantially at a mid-point between a pair of projections or jaws 324.

It will be appreciated that the compression gaps 325A, 325B may allow the ring 321 to be expanded or increased in diameter, at least temporarily, as it is applied to the top 130 of the thumb stick 103. The natural or inherent resilience of the material from which the ring 321 is formed may return the ring 321, at least partially, to its original or initial diameter. This may provide at least a part of a gripping force of the jaws 326 on the top 130 of the thumb stick 103.

The collet 320 is configured to removably attach to the thumb stick 103 with the ring 321 resting on an upper surface of the top 130 of the thumb stick 103 and extending down to wrap around or engage the sides of top 130 of thumb stick 103. The collet 320 may comprise at least one protuberance or abutment 328 extending inwardly from an upper portion of the ring 321 to provide a return for resting upon the upper surface of the top 130 of the thumb stick 103. In the illustrated embodiment, a pair of abutments 328 are provided substantially above, or aligned with, each projection or jaw 324, the abutments 328 of each pair of abutments 328 are spaced apart by the upper compression gap 325B. The upper compression gap 325B can be considered to interrupt an abutment 328. The ring 321 may be made of a semi-flexible material and the compression gaps 325A, 325B are located in the ring 321 such that the diameter of the ring 321 can expand away from or contract towards the sides of the top 130 of the thumb stick 103 in response to pressure to provide a secure attachment to the top 130.

Cover 350 is configured to removably attach to the collet 320 to tighten the collet 320 around the top 130 to securely attach the adapter 300 to the thumb stick 103. The cover 350 comprises an outer side/engagement surface 352 and an inner side 354 opposite the outer side 352. The outer side/engagement surface 352 provides a surface for a user's thumb to engage when the adapter 300 is attached to a thumb stick 103 in order to operate the thumb stick 103. The upper portion of the engagement surface 352 may be concave, convex, or any other desired shape. The inner side 354 provides a securing mechanism 340/342 for removably attaching the cover 350 to the collet 320.

In the embodiment of FIGS. 8A to 11 the cover 350 may press fit onto the collet 320 such that when the cover 350 is attached to the collet 320, the cover 350 provides a compression pressure or force causing a portion of the ring 321 of the collet 320 to contract or reduce in diameter, securing adapter 300 to the top 130 of the thumb stick 103. The securing mechanism 340/342 comprises a first part 340 and a second part 342. The first part 340 may comprise at least one rib or ridge 340 on an outer surface of the ring 321 and extending circumferentially thereabout. The at least one rib or ridge 340 may be interrupted by the compression gaps 325A, 325B.

In the illustrated embodiment, the ring 321 comprises a plurality of ribs or ridges 340, spaced apart from each other on an outer surface of the ring 321 and extending circumferentially thereabout. Each of the plurality of ribs or ridges 340 is interrupted by the compression gaps 325A, 325B. In this way the collet 320 may progressively tightened, when the cover 350 is attached. The ring 321 may comprise a conical outer surface, best illustrated in FIG. 8B, on which the ribs or ridges 340 are mounted or formed. The diameter of the ring 321, at least the external diameter, may increase as it approaches the projections or jaws 324.

The second part 342 may comprise at least one rib or ridge 342 on an inner surface of the sidewall or skirt of the cover 350 and extending circumferentially thereabout. The second part 342 may comprise plurality of ribs or ridges 340, spaced apart from each other, on an inner surface of the sidewall or skirt of the cover 350 and extending circumferentially thereabout, best shown in FIG. 9A.

In other embodiments, the cover 350 may attach to the collet 320 by another method to provide pressure or force to the collet 320 to secure the adapter 300 to the top 130 of the thumb stick 103. For example, in an alternate embodiment the cover 350 could be configured to screw down on to the collet 320 to provide pressure or force to the ring 321, such as by threads formed on the inner side 354 of the cover 350 to engage the outside surface of the ring 321.

The cover 350 when attached to the collet 320 may prevent or inhibit expansion of the collet 320, of the jaws 326, and/or ring 321.

For the press fit cover 350 of FIGS. 8A to 11, the inner side 354 comprises a circular or annular indentation or channel 355 surrounding a central protrusion 357 extending from the inner surface of top of cover 350, best shown in FIG. 9A. The cover 350 also includes a series of gaps 358 in the side wall of cover 350. The circular indentation 355 is located and dimensioned to receive a top edge of the ring 321 of the collet 320 (including the abutments 328) while the central protrusion 357 fits into the opening 323 of the ring 321 when the cover 350 is press fit onto the collet 320. In an embodiment, the central protrusion 357 is slightly oversized with respect to the ring 321 and/or abutments 328 of the collet 320. In such embodiments, press fitting the cover 350 causes the central protrusion 357 to force the upper portion of the ring 321 to expand outward, while at the same time forcing the lower portion of ring 321 and the projections 326 inward and downward, causing the compression gaps 325A to close or contract, and resulting in the bottom portion of the ring 321 and the projections 324 to secure tightly to the sides and underside of the top 103 of the thumb stick 130 The downward and/or inward pressure prevents the collet 320 (and therefore adapter 300) from slipping, moving or twisting with respect to the top 103 of the thumb stick 130 when the cover 350 is press fit to the collet 320.

The gaps 358 of the cover 350 are located and dimensioned to engage with the projections 324 of the collet 320, further securing the cover 350 to the collet 320, and allowing for the cover 350 material to be the primary material exposed to the user when the adapter 300 is attached to the top 130 of the thumb stick 103. For instance, FIGS. 10A and 10B illustrate the adapter 300 with the cover 350 press fit onto the collet 320 (the thumb stick 103 is not shown). As illustrated in FIGS. 10A and 10B, when the cover 350 is attached to the collet 320 the engaging surface 352 engaged by a user is not only on the top of the adapter 350, but also includes the outer surface of cover 350 which extends down to cover the side of the top 130 of thumb stick 103. As with the cover 250 and the collet 220 above, the cover 350 and the collet 320 may be made or formed from the same material, while in other embodiments the cover 350 may be formed from or made from a different material than the collet 320. Any suitable material for the cover 350 and/or collet 320 may be used such as a plastic, resin, elastomer, polyvinyl chloride, polystyrene, vinyl, or other deformable material. Since the cover 350 is removable, covers 350 of different materials, colours, shapes, thicknesses, widths, textures, etc. can be used with the adapter 300 as desired by a user. Additionally, the cover 350 may be customizable for a particular use or user, such as by using a thermo or thermoset plastic or polymer, or other customizable material, for part or all of the cover 350.

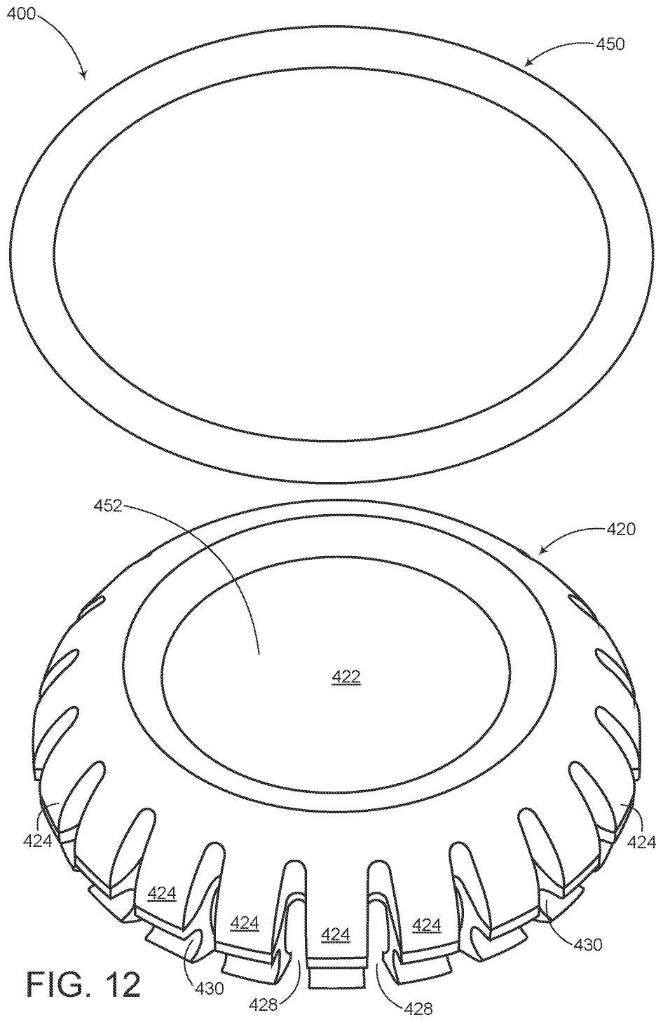

FIGS. 12 to 14B illustrate a third embodiment of the adapter 400 comprising a removable cover 420 securable to the top 130 of the thumb stick 130 via a securing mechanism 450. In this embodiment, the inner surface of removable cover 420 is configured to attach to and grip the top 130 of thumb stick 103, while the outer surface of cover 420 is configured to provide an engagement surface 452 for a user. The engagement surface 452 may be concave, convex, or any other desired shape. Cover 420 includes a side wall configured to extend over and secure to the side of the top 130 of thumb stick 103. In the illustrated embodiment, the side wall comprises a series of fingers or claws 424 separate by gaps 428 where the fingers 424 extend downwardly from the engagement surface 452 of the cover 420 to wrap around, engage or grasp the sides of top 130 of thumb stick 103. The fingers 424 may be shaped and sized to also grip or attach to a bottom surface of top 130 of thumb stick 103 to help secure the cover 420 to the top 130. The fingers 424 may be configured with a ledge or projection 426 at a free or distal end thereof, the free or distal end of the fingers 424 being opposite a fixed end connected to a central portion 422 of the cover 420. In an embodiment, the projections 426 may comprise a ledge or shelf extending from an inside face of the fingers 424.

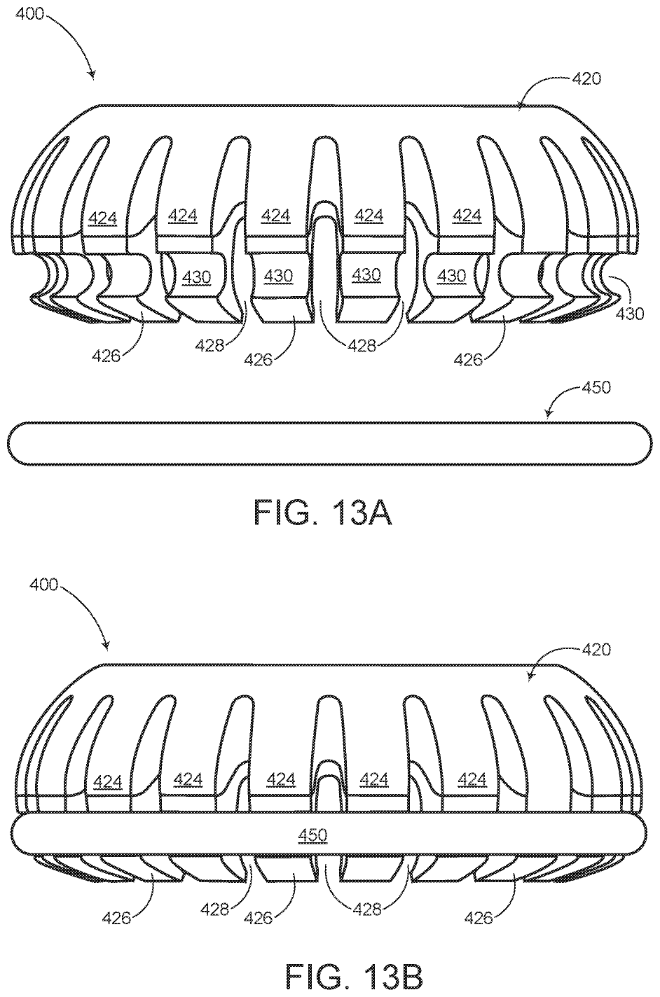

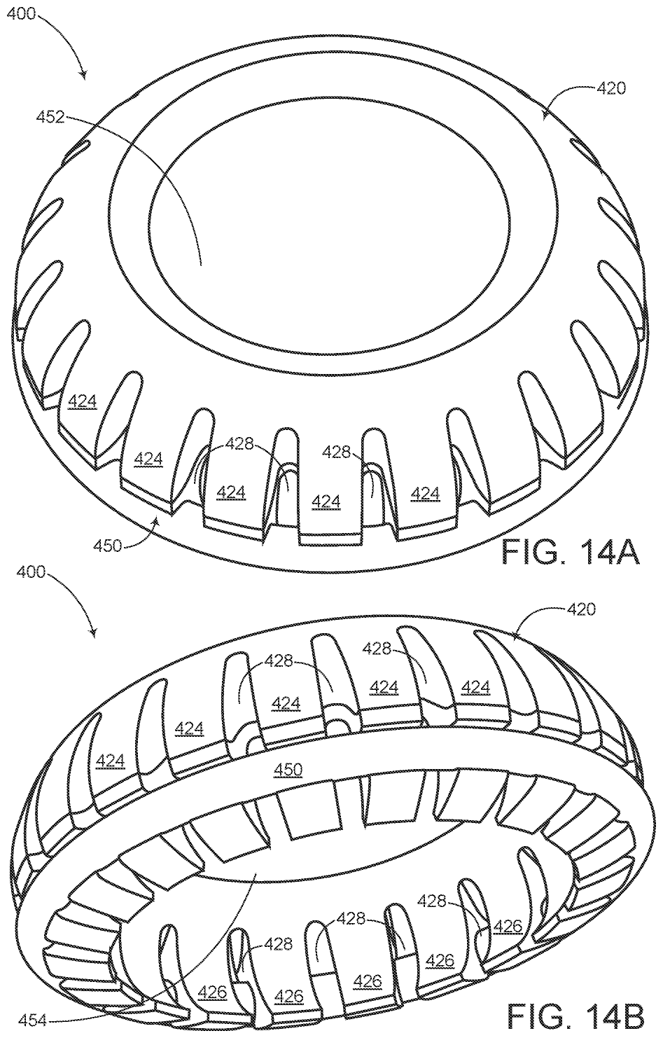

The outer surface of the cover 420 also provides a receiver for securing mechanism 450 to attach to the cover 420, which in the illustrated embodiment comprises a series of indentions or recesses 430 formed in the fingers 424. The indentions 430 are configured to accept the securing mechanism 450 which in the illustrated embodiment comprises a semi-rigid ring. The indentions or recesses 430 define a waist in the outer surface of the cover 420. As illustrated in FIGS. 13B, 14A, and 14B, the securing mechanism/ring 450 is designed to press-fit/slip over the cover 420 and tightly fit into the indentions 430. The securing mechanism/ring 450 is dimensioned and formed of a material (such as an elastomer) such that when located in the receiver, the ring 450 provides a downward and/or inward force to the fingers 424, securing the inner surface of the fingers 424 against the top 130 of the thumb stick 103 with sufficient force to prevent or inhibit the cover 420 (and adapter 200) from moving, slipping, or twisting on the thumb stick 103 in use.

In other embodiments or implementations, a different securing mechanism 450 may be used. For example, in an alternate implementation, the side wall/fingers 424 of the cover 420 could be configured with threads instead of the indentions 430. In such an implementation the securing mechanism 450 could be a rigid ring with threads on an inner surface configured to screw onto the cover 420 to provide pressure or force to the fingers 424 securing the inner surface of the fingers 424 against the top 130 of thumb stick 103. As will be understood, other configurations of the securing mechanism 450 are also possible.

Cover 420 of FIGS. 12 to 14B may be comprised of a single material or may be comprised of different materials. For example, in an implementation, the inner surface of cover 420, including fingers 424 may be formed from a first material and the outer surface of cover 420, including the engagement surface 452 and/or outer surface of the fingers 424 may be comprised of a second material removably attached or permanently attached to or moulded onto the first material (such as by overmoulding). In such implementations, the first material may be made be a material that is more durable and/or that will better secure the cover 420 to the top 130 of the thumb stick 103, while the second material may provide a better engagement surface 452 for a user. Since the cover 420 is removable, covers 420 of different materials, colours, shapes, thicknesses, widths, textures, etc. can be used with the adapter 400 as desired by a user. Additionally, the cover 420 may be customizable for a particular use or user, such as by using a thermo or thermoset plastic or polymer, or other customizable material, for part or all of the cover 420.

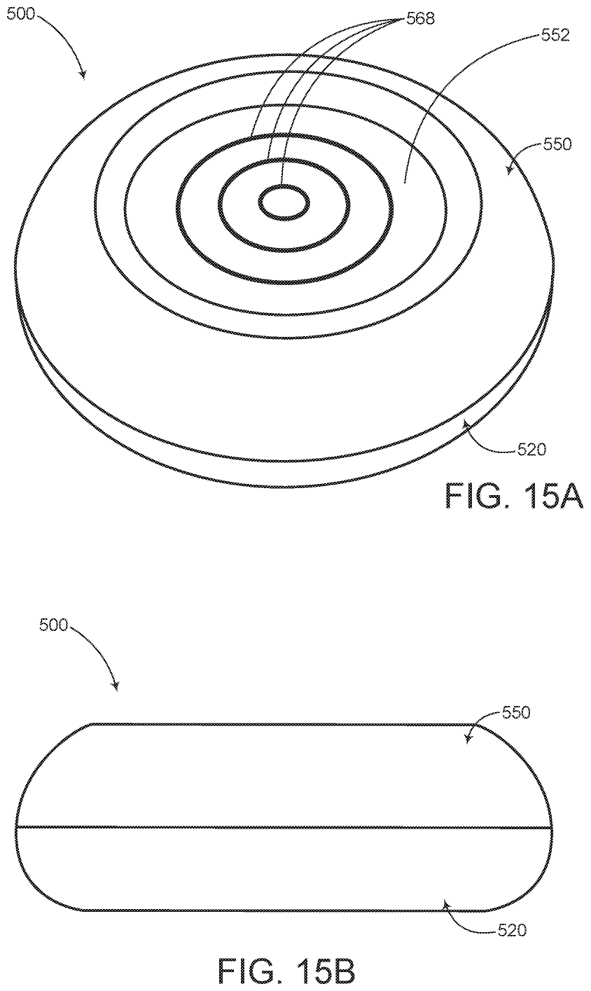

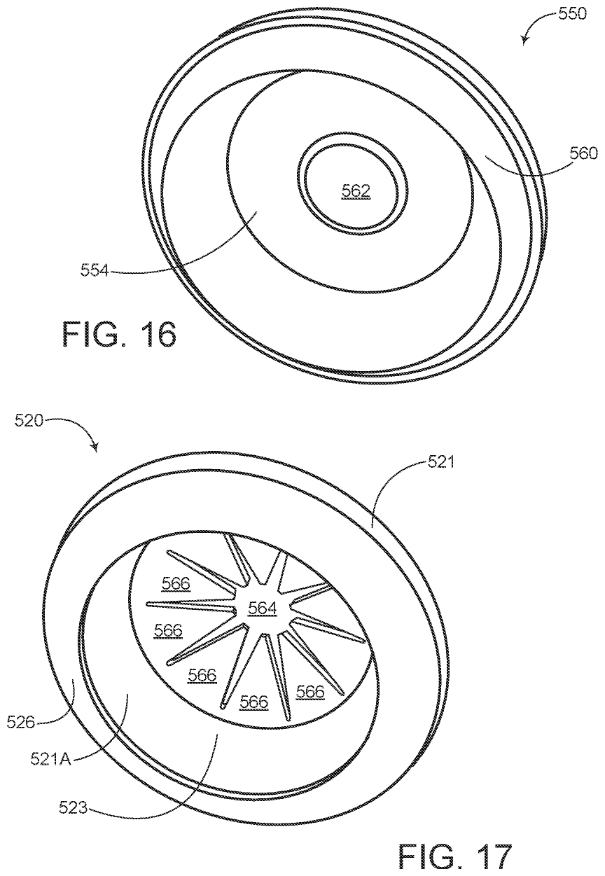

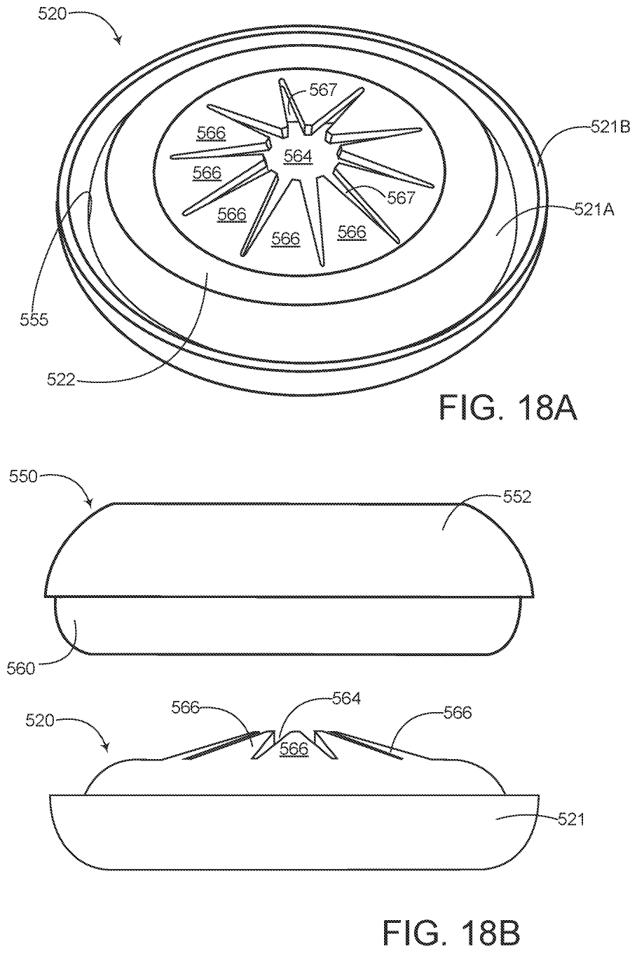

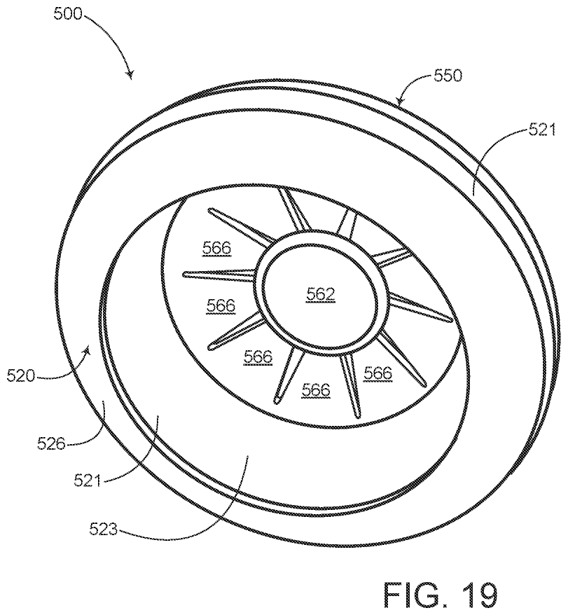

FIGS. 15A to 20B illustrate a fourth embodiment of a multi-part removable adapter 500 configured to removably attach to a control of controller 110, such as thumb stick 103. Adapter 500 comprises a collet 520, as shown in FIGS. 17 and 18A, configured to grip the top 130 of the thumb stick 103 and a cover 550, as shown in FIG. 16, configured to attach to the collet 520 and provide an engagement surface for a user. In the illustrated embodiment, the collet 520 comprises a central portion 522 with a central opening 564. A first, inner, wall 521A depends from the central portion 522 and surrounds the central portion 522. A second, outer, wall 521B depends from the first, inner, wall 521A and surrounds or circumscribes the first, inner, wall 521A.

The first, inner, wall 521A extends generally outward and downward from the central portion 522.

The second, outer, wall 521B extends generally outward and upward from an outermost or lowermost edge of the first, inner, wall 521A.

A recess or channel 555 is defined between the inner and outer walls 512A, 521B.

An annular projection or skirt 526 extends generally inward from the inner and/or outer walls 512A, 521B and provides a ledge or shelf extending from an inside face of the inner wall 521A. The annular projection 526 may be shaped and sized to allow the collet 520 to grip or attach to a side and/or bottom surface of the top 130 of the thumb stick 103 to help secure the collet 520 to the top 130 while at the same time preventing the collet 520 (and adapter 500) from twisting on the thumb stick 103 in use.

An annular projection or skirt 526 defines an opening 523 in or through which the top 130 of the thumb stick 103 is receivable.

The collet 520 comprises a first part of a securing mechanism for securing the cover 550 to the collet 520. The first part of the securing mechanism comprises the central opening 564. A plurality of teeth or tabs 566 are disposed about the central opening 564. Each of the teeth or tabs 566 may be separated from its adjacent neighbour by a cutaway 567 in the form of a cut, slot or “V” shaped recess extending radially outward from the central opening 564. The teeth or tabs 566 define, at least a part of a dome or diaphragm.

The cover 550 is configured to removably attach to the collet 520 to tighten the collet 520 around the top 130 to securely attach the adapter 500 to the thumb stick 103. The cover 550 comprises an outer side/engagement surface 552 and an inner side 554 opposite the outer side 552. The outer side/engagement surface 552 provides a surface for a user's thumb to engage when the adapter 500 is attached to a thumb stick 103 in order to operate the thumb stick 103. The upper portion of the engagement surface 552 may be concave, convex, or any other desired shape. The inner side 554 provides a second part of the mechanism for the cover 550 to be removably attached to the collet 520.

The cover 550 may comprise a collar or annulus 560 receivable in the recess or channel 555 defined between the inner and outer walls 512A, 521B.

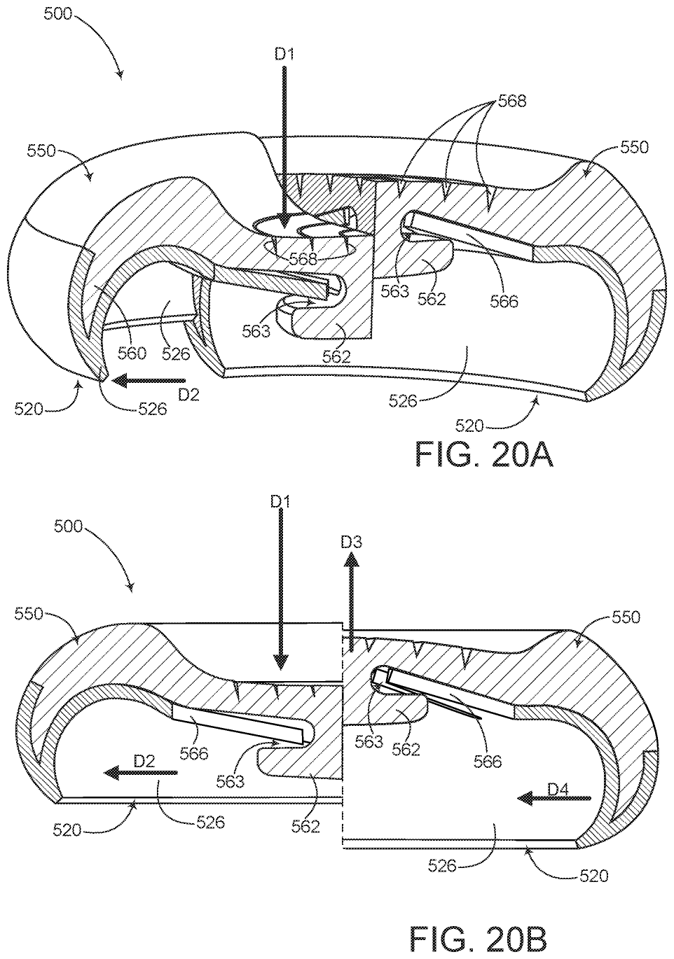

The cover 550 comprises a second part of a securing mechanism for securing the cover 550 to the collet 520. The second part comprises a retainer pin 562 comprising a head in the form of a knob or disc depending from an inner surface of a central region of the cover 550 by a shaft. A recess 563 (see FIGS. 20A and 20B) is defined between the knob or disc and the inner surface the cover 550. The recess 563 is configured to receive portions of the teeth or tabs 562 of the collet 520.

An upper surface of the cover 550 comprises fitment or compression gaps 568 in the form of annular cut or channels. The fitment or configuration gaps 568 allow the cover 550 to adjust its geometry, its size and/or shape. As shown in FIGS. 20A and 20B downward depression of the centre of the cover 550, as indicated by direction arrow D1 forces the teeth or tabs 562 of the collet 520 downward in doing so the inner and outer walls 521A, 521B and skirt 526 are displaced outwardly (as indicated by direction arrow D2) in doing so the opening 523 is increased in size.

When the centre of the cover 550 is released the cover 550 and the collet 520 return to a rest position. The centre of the cover 550 moves upwardly, as indicated by direction arrow D3 along with the teeth or tabs 562 of the collet 520, in doing so the inner and outer walls 521A, 521B and skirt 526 are displaced inwardly (as indicated by direction arrow D4) in doing so the opening 523 is decreased in size. The collet 520 grips or attaches to a side and/or bottom surface of the top 130 of the thumb stick 103 to help secure the collet 520 to the top 130 while at the same time preventing the collet 520 (and adapter 500) from twisting on the thumb stick 103 in use.

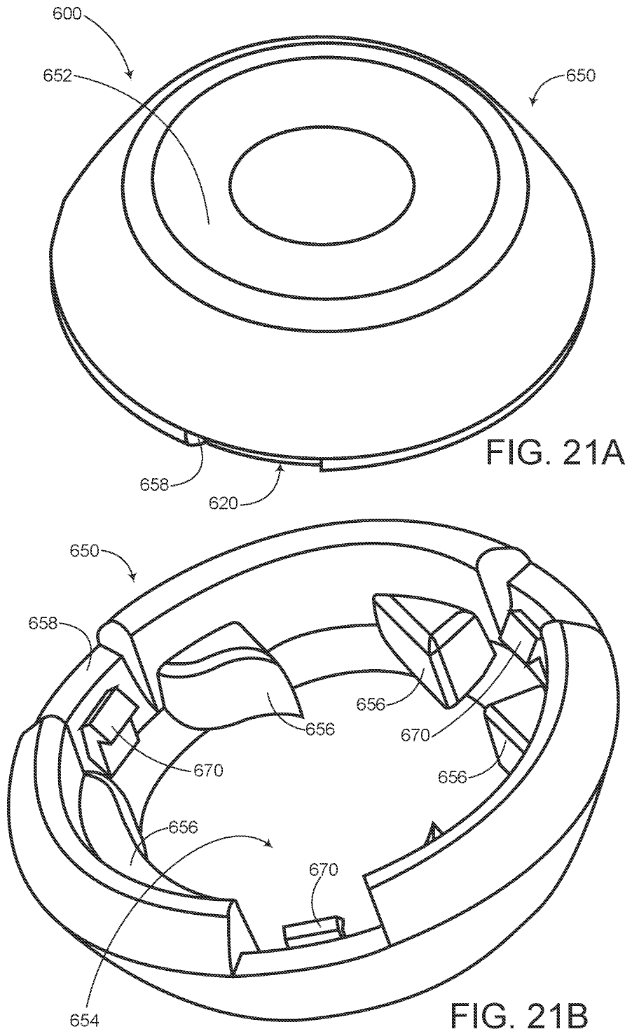

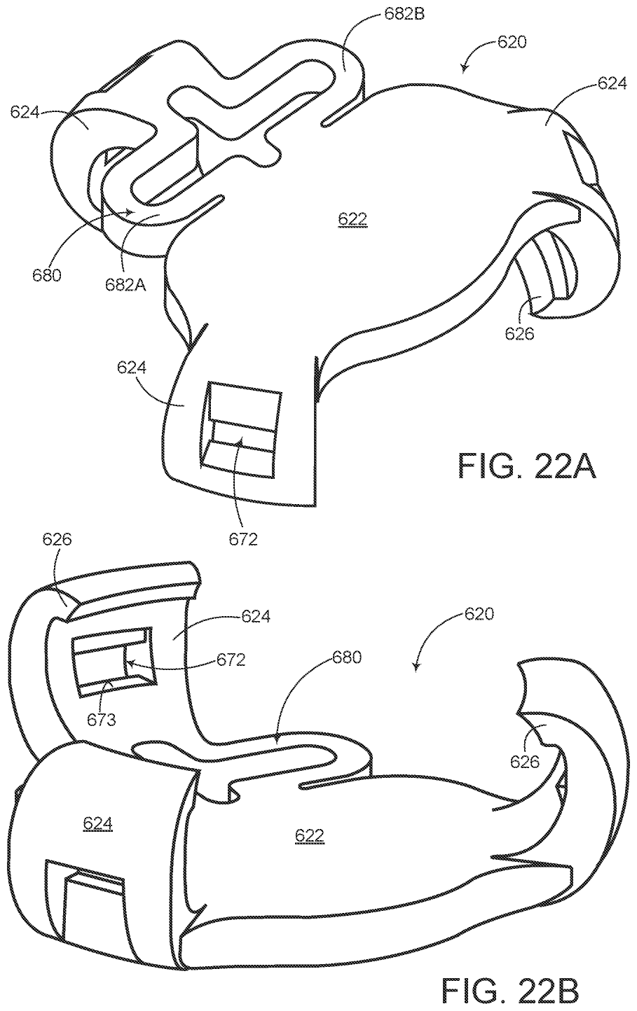

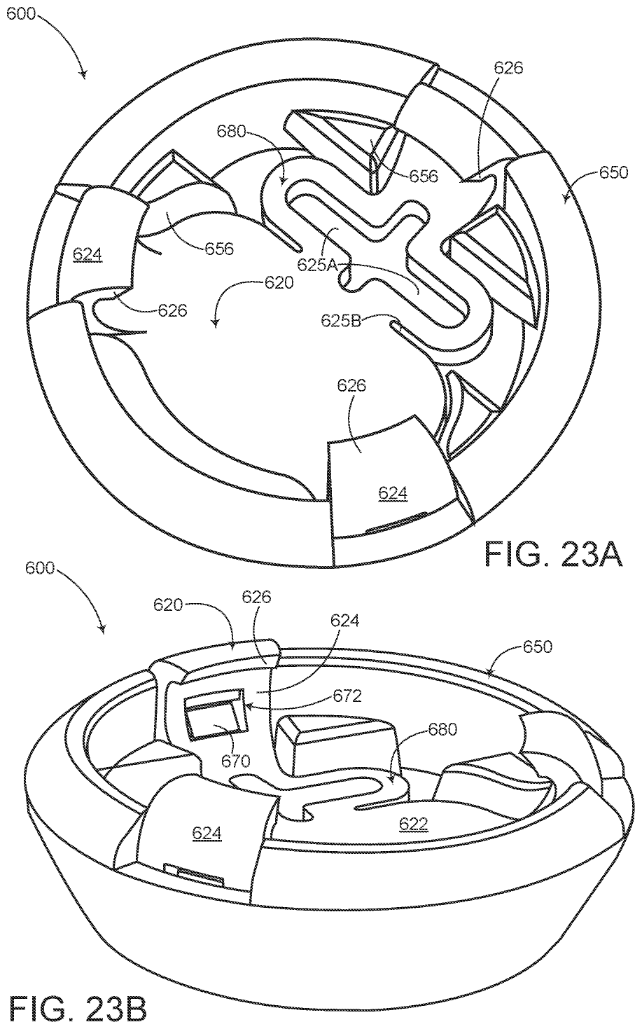

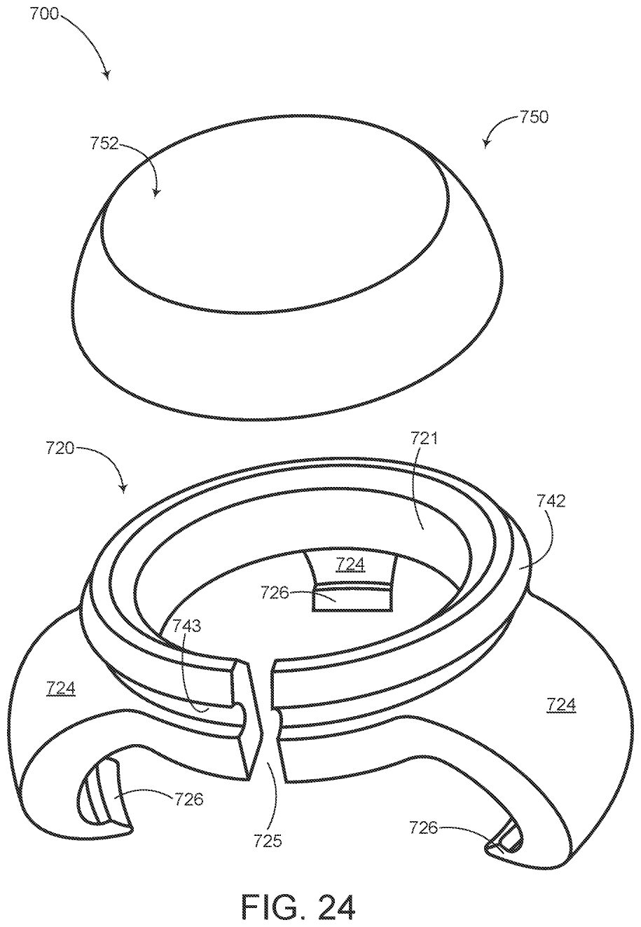

FIGS. 21A to 23B illustrate a fifth embodiment of a multi-part removable adapter 600 configured to removably attach to a control of controller 110, such as thumb stick 103. Adapter 600 comprises a collet 620, as shown in FIGS. 22A and 22B, configured to grip the top 130 of the thumb stick 103 and a cover 650, as shown in FIG. 21B, configured to attach to the collet 620 and provide an engagement surface for a user. In the illustrated embodiment, the collet 620 comprises a central portion 622 from which a plurality of extensions or jaws 624 extend. The extensions 624 may be nonlinear or curved in shape so as to extend generally outward and downward from the central portion 622 best illustrated in FIG. 22B.

The collet 620 is configured to removably attach to the thumb stick 103 with central portion 622 resting on an upper surface of the top 130 of the thumb stick 103, and the extensions 624 wrapping around, or engaging, the sides of top 130 of the thumb stick 103. The collet 620 receives the head 130 of the thumb stick 103. One or more of the extensions 624 may be configured with a ledge or projection 626 at the end of the extension 624 opposite the end connected to the central portion 622. In an embodiment, the projections 626 may comprise a ledge or shelf extending from an inside face of the extensions 624. The projection 626 may be shaped and sized to allow the extensions 624 to grip or attach to a bottom surface of the top 130 of the thumb stick 103 to help secure the collet 620 to the top 130 while at the same time preventing the collet 620 (and adapter 600) from twisting on the thumb stick 103 in use.

The extensions 624 may be made of a semi-flexible material with one end of the extensions 624 rigidly attached to the central portion 622 such that the extensions 624 can bend or flex downwards and inwards towards the upper surface and/or sides of the top 130 of the thumb stick 103 in response to pressure to provide a secure attachment to the top 130. In another embodiment, the extensions 624 may be made of a more rigid material and may be pivotally or rotationally attached to the central portion 622 such that the extensions 624 can pivot or rotate downwards and/or inwards somewhat towards the upper surface and/or sides of the top 130 of the thumb stick 103 in response to pressure to provide a secure attachment to the top 130.

At least one of the extensions 624 is coupled or connected to the central portion 622 by a resilient member 680. The resilient member 680 comprises at least one, preferably two, U-shaped spring elements 682A, 682B. A first end of the U-shaped spring element 682A, 682B is connected or mounted to the central portion 622. A second end of the U-shaped spring element 682A, 682B is connected or mounted to the at least one extension 624.

The resilient member 680 allows movement of the at least one extension 624 radially of the central portion 622 of the collet 620. The at least one extension 624 may be displaced inwardly or outwardly, the resilient member 680 returns or at least encourages the at least one extension 624 to a rest or equilibrium position.

Each of the extensions or limbs 624 comprises a first part 672 of a locking mechanism. The locking mechanism take the form of a push-fitting in the illustrated embodiment but alternative locking mechanism may be employed. The first part takes the form of a receiver for receiving a latch or detent 670, the detent 670 is provided by the cover 650. The detent 650 may take the form of a barb or arrowhead. The cover 650 provides the second part of the locking mechanism, in the illustrated embodiment the detent 670 mounted to, or extending from, the inner surface of the side wall of the cover 650.

The interior 654 of the cover 650 comprises a plurality of protrusions 656 which define a cavity in which the collet 620 is received, the collet 620 fits in the cavity and prevents or inhibits movement of the collet within the cover 650. The cover 650 may be closely fitted to the collet 620 to enhance responsiveness, that is to say force applied to the outer surface of the cover 650 by a user is transferred rapidly to the collet 620 and subsequently the thumb stick 103.

The protrusions 656 may be configured to act upon the collet 620 to increase grip of the collet to the head 130 of the thumb stick 103. The protrusions 656 may engage the resilient member 680 compressing the spring elements 682A, 682B so as to close or tighten the jaws 624 onto the head 130 of the thumb stick 103. The collet 620 comprises one or more slot or gaps 625A, 625B which allow the resilient member 680 to be compressed.

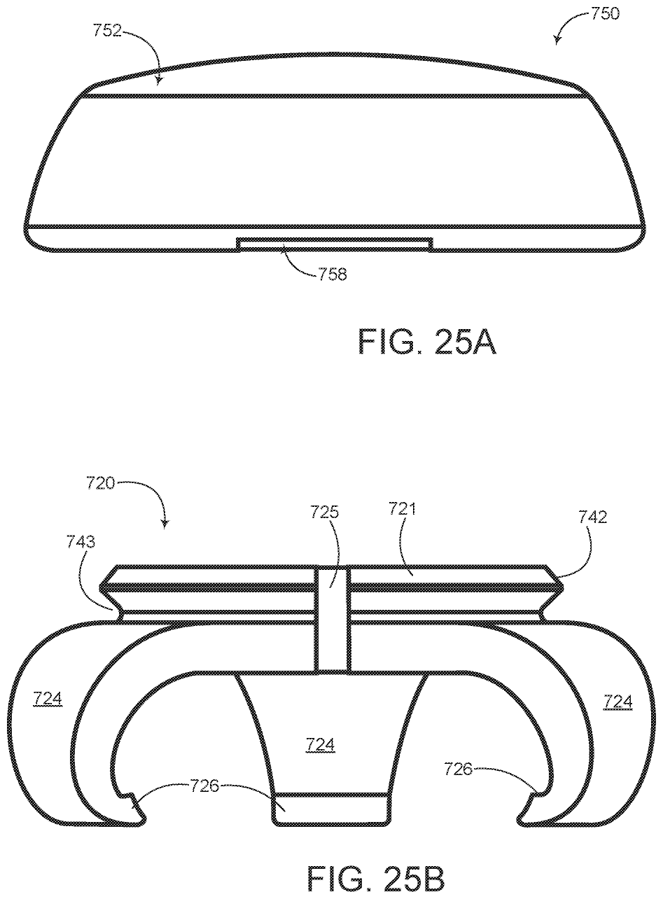

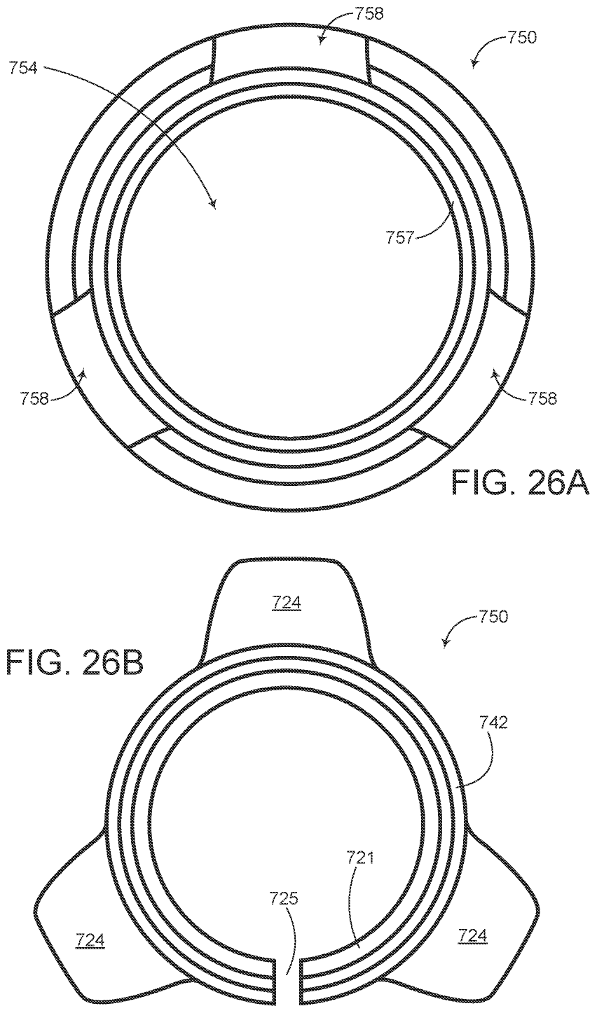

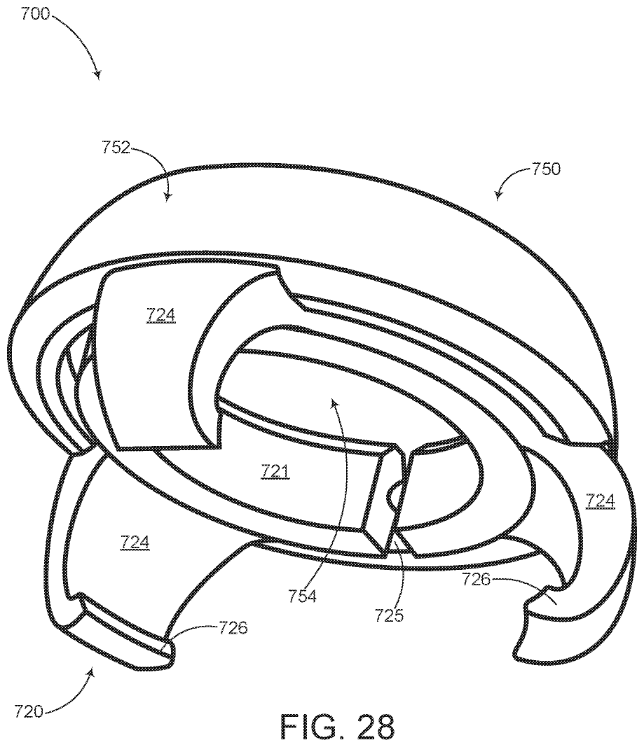

FIGS. 24 to 28 illustrate a sixth embodiment of a multi-part removable adapter 700 configured to removably attach to a control of controller 110, such as thumb stick 103. Adapter 700 comprises a collet 720, as shown in FIGS. 25B and 27B, configured to grip the top 130 of the thumb stick 103 and a cover 750, as shown in FIGS. 25A and 27A, configured to attach to the collet 720 and provide an engagement surface for a user. In the illustrated embodiment, the collet 720 comprises a main body in the form of a ring 721 from which a plurality of extensions or jaws 724 extend. The extensions 724 may be nonlinear or curved in shape so as to extend generally outward and downward from the ring 721 best illustrated in FIG. 25B. The ring 721 comprises a cut-out 721 in the form of a slot forming a gap and interrupting the ring 721. The ring 721 is formed from a semi-flexible resilient material configured such that the diameter of the ring 712 can be increased or decreased; opening or closing the gap formed by the cut-out 725. In this way the distance between the jaws 724 can be increased or decreased. This enable the collet 720 to be adjusted to accommodate the head 130 of a control 103 and to enable a tight or close fit of the collet 720 to the head 130 to be achieved.

The cover 750 when mounted to the ring 721 of the collet 720 may compress the ring 721 to reduce the diameter or at least prevent or inhibit opening of the gap whereby preventing or inhibiting an increase in diameter of the ring 721.

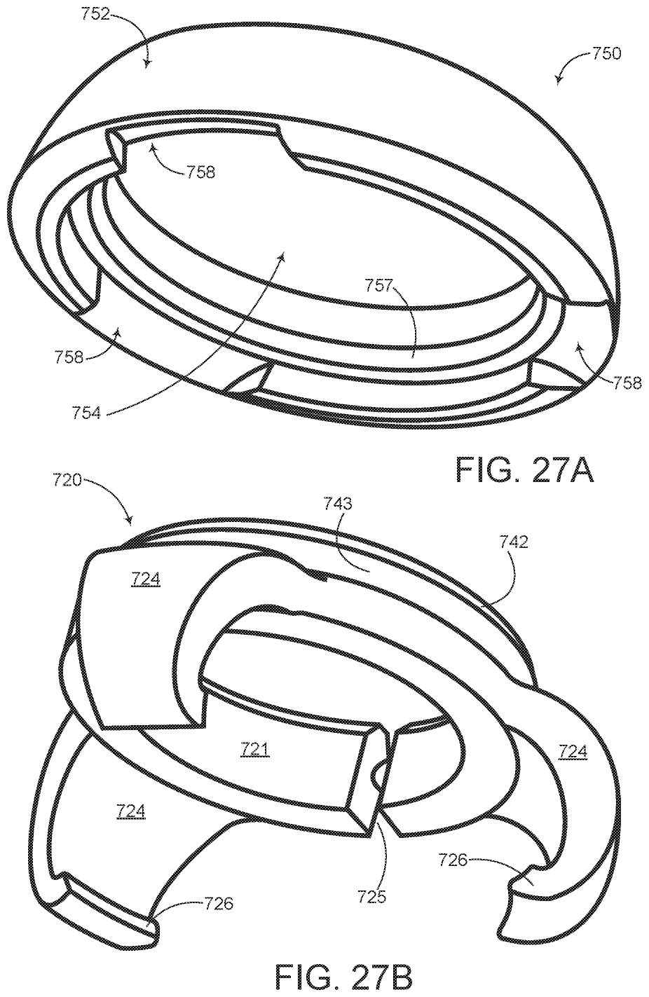

The cover 750 may be mounted to the ring 721 by a press or snap fitting. The ring 712 comprises a groove or recess 743 in which a portion of the cover 750 is received. The cover comprises an annular projection 757, best shown in FIGS. 26A and 27A. The annular projection 757 is provided in an interior 754 of the cover 750 and has the effect of reducing the diameter of the interior 754. The ring 721 may be chamfered 742 along an upper, outer, edge thereof to facilitate insertion of the collet 720 into the cover 750. The annular projection 757 is received in the groove or recess 743 of the collet 720 to lock or secure the cover 750 to the collet 720.

The side wall of the cover 750 also includes at least one gap 758, the illustrated embodiment comprises three gaps 758. A gap 758 may be provide for each projection 724 of the collet 720. An orifice in the base of the cover 721 receives the ring 721 when the cover 750 is press fit onto the collet 720.

The gaps 758 of the cover 750 are located and dimensioned to engage with the projections 724 of the collet 720, a portion of a projection 724 is received in each gap 758, portions of the side wall of the of the cover 750 defined by the gaps 758 provide end stops limiting travel of the collet 720 with respect to the cover 750, in particular rotation of the collet 720 and cover 750 with respect to each other.

The present disclosure provides an adapter 200; 300; 400; 500; 600; 700 for use with input apparatus 110 for a computer such as a game controller. The adapter 200; 300; 400; 500; 600; 700 comprises a first part 220; 320; 420; 520; 620; 720 having a gripping device 224; 324; 426; 526; 624; 724. The gripping device 224; 324; 424; 526; 624; 724 may comprise at least two jaws 224; 324; 424; 624; 724 for gripping the head 130 of a control 103. The at least two jaws 224; 324; 424; 624; 724 are mounted to a main body 222; 321; 452; 622, 721. The gripping device 224; 324; 424; 526; 624; 724 may comprise a mouth or socket 526 for receiving a portion of the input apparatus 110.

The first part may comprise a flexure or living hinge, the flexure may be resiliently biased towards a rest or equilibrium position. The flexure enables the jaws 224; 324; 424; 624; 724 to be opened and closed.

The adapter 200; 300; 400; 500; 600; 700 comprises a second part 250; 350; 450; 550; 650; 750 mountable to the first part 220; 320; 420; 520; 620; 720 and providing a reinforcement device or closure device for preventing or inhibiting opening or expansion of the gripping device 224; 324; 424; 526; 624; 724 when mounted to the first part 220; 320; 420; 520; 620; 720. The second part 250; 350; 450; 550; 650; 750 may comprise a ring or annular region surrounding at least a portion of the first part 220; 320; 420; 520; 620; 720. The ring or annular region may encircle the at least two jaws 224; 324; 424; 624, 724 or socket 526. The first part 220; 320; 420; 520; 620; 720 may comprise one or more cut-outs, slots or gaps 223, 229; 325A, 325B; 428; 567; 625A, 625B; 725, also referred to herein as fitment or compression gaps, enabling the jaws 224; 324; 424; 624; 724 or socket 526 to be displaced inwardly or generally towards each other. The jaws 224; 324; 424; 624; 724 may comprise a projection 226; 326; 426; 626; 726, or a recess, defining a ledge or shelf for engaging an undercut or bottom surface of the head 130 of the control 103. The undercut or bottom surface of the head 130 of the control 103 may substantially or generally oppose a top surface of the head 130 of the control 103.

The second part 550 may comprise one or more cut-outs, slots or gaps 568 enabling the displacement or deformation of at least a portion of the second part 550, and may facilitate inward displacement of said portion of the second part 550.

It is envisaged that in various embodiments controller 110 may be coupled to a games console or computer by a wired connection or by a wireless connection device. It is also envisaged that the controller 110 may be constructed as a shell or caddy into which a hand-held electronic device such as, but not limited to, a mobile telephone (smartphone) or tablet computer is inserted, the caddy comprising control actuators, thumb sticks and/or buttons (which are coupled to the electronic device either wirelessly or via physical or wired connection) for interaction with or control of the electronic device.

It will be recognised that as used herein, directional references such as “top”, “bottom”, “front”, “back”, “end”, “side”, “inner”, “outer”, “upper” and “lower” do not limit the respective features to such orientation, but merely serve to distinguish these features from one another.

1-3. (canceled)

4. An input apparatus for a computer, the input apparatus comprising:
an outer case having a front face, a top face and a rear face opposing the front face;
a control located on the top face, the apparatus being shaped to be held in both hands of a user such and the user's index fingers are positioned to operate the control located on the top of the apparatus;
a second control located on the front face and positioned to be operated by a thumb of the user; and
an adapter configured to be removably attached to the second control, the adapter comprising:
a collet configured to couple to a top of the second control, and
a cover configured to removably attach to the collet in a manner that secures the collet to the second control, wherein the cover provides an engagement surface for the user's thumb.

5-6. (canceled)

7. The input apparatus of claim 4, wherein the second control is a thumb stick.

8. The input apparatus of claim 7, wherein the collet comprises:
a central portion configured to engage an upper surface of the top of the thumb stick, and
a plurality of extensions extending outwardly from the central portion, the plurality of extensions configured to engage a side of the top of the thumb stick.

9. The input apparatus of claim 8, wherein the cover comprises a plurality of protrusions configured to engage the side of the top of the thumb stick when the cover is attached to the collet, and wherein portions of the side wall of the cover located between the protrusions are configured to engage and apply pressure to the plurality of extensions to secure the collet to the thumb stick.

10. The input apparatus of claim 9, wherein the cover is configured to apply force to the extensions in two directions.

11. The input apparatus of claim 7, wherein the collet comprises:
a ring with a centre opening configured to engage a side of the top of the thumb stick, the ring configured with a plurality of compression gaps extending upwards from a lower edge of the ring, and
a plurality of projections extending from the bottom edge of the ring.

12. The input apparatus of claim 7, wherein the collet comprises:
a ring with a centre opening configured to engage a side of the top of the thumb stick, the ring configured with a compression gap interrupting the ring, and
a plurality of projections extending from the bottom edge of the ring.

13. The input apparatus of claim 11, wherein the cover comprises: a central protrusion configured to apply pressure to the ring when the cover is attached to the collet such that the collet is secured to the thumb stick.

14. The input apparatus of claim 4, wherein the cover is formed from a first material and the collet is formed from a second material different from the first material.

15. The input apparatus of claim 7, wherein the collet comprises:
a central portion configured to engage an upper surface of the top of the thumb stick,
an inner annular wall depending from the central portion and configured to engage a side of the top of the thumb stick; and
an outer annular wall extending from the inner wall to define a channel therebetween.

16. The input apparatus of claim 14, wherein the collet comprises a skirt extending inwardly from the inner wall and defining a shelf for engaging a bottom of the top of the thumb stick.

17. The input apparatus of claim 14, wherein the cover comprises a collar configured to be received in the channel.

18. The input apparatus of claim 4, wherein the cover is configured to snap-fit to the collet.

19. The input apparatus of claim 4, wherein the collet comprises a central portion having an opening defined in part by an aperture and in part by an annular series of displaceable tabs disposed about the aperture and the cover comprises a retainer pin configured to push-fit into the opening in the collet.

20. An adapter for use with a game controller, the game controller shaped to be held in both hands of a user and comprising an outer case having a front face, a top face and a rear face opposing the front face, a control located on the top face in a position to be operated by a user's index finger and a thumb stick located on the front face and positioned to be operated by a thumb of the user, wherein the adapter comprises;
a first part configured to removably couple to a top of the thumb stick, and
a second part configured to removably attach to the first part in a manner that applies force to the first part and secure the first part to the thumb stick.

21-22. (canceled)

23. The adapter of claim 20, wherein the first part comprises a collet configured to engage the thumb stick and the second part comprises a cover configured to fit over the collet to secure the collet to the thumb stick, the cover providing an engagement surface for the thumb of the user.

24. (canceled)

25. The adapter of claim 23, wherein the cover is configured to press-fit onto the collet.

26. The adapter of claim 23, wherein:
the collet comprises:
a central portion configured to engage an upper surface of the top of the thumb stick, and
a plurality of extensions extending outwardly from the central portion, the plurality of extensions configured to engage a side of the top of the thumb stick; and
the cover comprises:
a plurality of protrusions configured to engage the side of the top of the thumb stick when the cover is attached to the collet, and wherein a plurality of portions of the side wall of the cover located between the protrusions are configured to engage and apply pressure to the plurality of extensions to secure the collet to the thumb stick.

27. The adapter of claim 26, wherein the cover is configured to apply force to the extensions in two directions.

28. The adapter of claim 23, wherein:
the collet comprises:
a ring with a centre opening configured to engage a side of the top of the thumb stick, the ring configured with a plurality of compression gaps extending upwards from a lower edge of the ring, and
a plurality of projections extending from the bottom edge of the ring; and
the cover comprises:
a central protrusion configured to apply pressure to the ring when the cover is attached to the collet such that the collet is secured to the thumb stick.

29. (canceled)
